(19) United States
(12) Patent Application Publication
(10) Pub. No.: US 2026/0278451 A1
(43) Pub. Date: Sep. 17, 2026

(54) NOISY QUANTUM CHANNEL ERROR MITIGATION

(71) Applicant: NVIDIA Corporation, Santa Clara, CA (US)

(72) Inventors: Yuval Idan, Rision Le Zion (IL); Taylor Lee Patti, Orange, CA (US); Elad Mentovich, Tel Aviv (IL)

(21) Appl. No.: 19/537,882

(22) Filed: Feb. 12, 2026

Related U.S. Application Data
(63) Continuation-in-part of application No. 19/295,997, filed on Aug. 11, 2025.
(60) Provisional application No. 63/771,789, filed on Mar. 14, 2025.

(51) Int. Cl. G06N 10/70

(52) U.S. Cl. CPC G06N 10/70

(57) ABSTRACT

Systems and methods for implementing noisy quantum channel error mitigation are described. For example, a method can include providing to a machine learning model, input data indicative of an original quantum state of a quantum system that is modified by an amount of noise added by a non-unitary quantum communication channel. The machine learning model is trained to predict the original quantum state in order to perform error mitigation by simulating an inverse of the non-unitary quantum communication channel to reverse one or more errors caused by the non-unitary quantum communication channel. The method can further include obtaining, from the machine learning model, output data indicative of the original quantum state, and causing a quantum computing system to perform at least one quantum computing operation, involving at least one of error mitigation or quantum state preparation, based on the output data.

### CROSS-REFERENCE TO RELATED APPLICATION(S)

The present application is a continuation-in-part of U.S. patent application Ser. No. 19/295,997, filed on Aug. 11, 2025, which claims the benefit of U.S. Provisional Patent Application No. 63/771,789, filed on Mar. 14, 2025, the entire contents of each of which are hereby incorporated by reference herein.

### TECHNICAL FIELD

The present application generally relates to quantum computing, and more particularly to noisy quantum channel error mitigation (e.g., error correction).

### BACKGROUND

Quantum metrology and computing networks can leverage the laws of quantum mechanics, such as superposition, entanglement, and so on, to perform measurements of physical systems, process measurements of physical systems, and perform computations. In quantum computing, a quantum circuit can include hardware and/or software for quantum computation, in which a quantum computation is performed using a sequence of quantum (logic) gates, quantum measurements, etc.

### BRIEF DESCRIPTION OF THE DRAWINGS

FIGS. 1A-1C are diagrams illustrating example systems for implementing noisy quantum channel error mitigation, in accordance with at least one embodiment;

FIG. 2 is a diagram illustrating an example method of utilizing weak measurements to perform error mitigation on noisy quantum channels, in accordance with at least one embodiment;

FIG. 3 is a diagram illustrating an example machine learning model architecture that can be used to implement noisy quantum channel error mitigation, in accordance with at least one embodiment;

FIGS. 4A-4B are example algorithms that can be used to implement a forward diffusion process that can be used to train a machine learning model to implement noisy quantum data error mitigation, in accordance with at least one embodiment;

FIG. 5 is a graph illustrating a relationship between average fidelity and the number of training examples, in accordance with at least one embodiment;

FIGS. 6A-6C are flowcharts illustrating example methods for training a machine learning model to implement noisy quantum channel error mitigation, in accordance with at least one embodiment;

FIG. 7 is a flowchart illustrating an example method for using a trained machine learning model to implement noisy quantum channel error mitigation, in accordance with at least one embodiment;

FIG. 8 illustrates a test set fidelity distribution, in accordance with at least one embodiment;

FIG. 9A illustrates a tensor-network representation of a separable quantum register, wherein independently parameterized subsystem states are propagated through local tensor operations without inter-subsystem coupling, in accordance with at least one embodiment;

FIG. 9B illustrates a tensor-network architecture in which initially separable local tensor states are transformed into non-separable tensors through the application of randomly selected controlled-NOT operations between pairs of local tensor subsystems, in accordance with at least one embodiment;

FIG. 10 illustrates an example vision transformer architecture that can be used to implement noisy quantum data error mitigation, in accordance with at least one embodiment;

FIGS. 11A-11B illustrate a network architecture, in accordance with at least one embodiment;

FIG. 12 illustrates an example datacenter, in accordance with at least one embodiment; and

FIGS. 13A-13B depict an example data center architecture, in accordance with at least one embodiment.

### DETAILED DESCRIPTION

Embodiments described herein are related to implementing noisy quantum channel error mitigation (e.g., error correction) techniques. Quantum computers have entered the NISQ (Noisy Intermediate-Scale Quantum) era, characterized by quantum devices that operate with a limited number of quantum bits (qubits). Variational Quantum Algorithms (VQAs) have emerged as a leading paradigm for demonstrating quantum advantage on NISQ devices. VQAs operate within a hybrid quantum-classical framework, synergistically combining the strengths of both classical and quantum computational paradigms. The core structure of VQAs involves encoding classical data into a parameterized cost function, which is then evaluated using a quantum system, such as a quantum simulator or actual hardware. Subsequently, a classical optimizer is employed to iteratively refine the parameters of the quantum circuit, aiming to minimize the cost function. This iterative feedback loop between the quantum and classical components can enhance model accuracy and mitigate the impact of noise inherent in NISQ devices. Hybrid quantum-classical frameworks, such as VQAs, strategically combine the strengths of classical computing, such as its robustness for optimization, control, and error mitigation, with the unique computational power of quantum systems, particularly for specific subroutines that are intractable for classical methods. This pragmatic strategy acknowledges the current limitations of quantum hardware, such as noise and a limited number of qubits.

A quantum circuit can be designed such that the horizontal axis is time, conventionally from left to right, single horizontal lines are qubits double lines are classical bits, and objects connected by these lines define operations performed on the qubits (e.g., measurements or gates). A quantum gate refers to a quantum circuit that operates on some number of qubits. Quantum gates are building blocks of quantum circuits, similar to classical logic gates for classical circuits. Quantum gates are operators that can be represented by matrices corresponding to an orthonormal basis. For example, a quantum gate can be a unitary operator represented by a unitary matrix. Examples of quantum gates includes the identity gate, the Pauli gates (e.g., Pauli-X, Pauli-Y and Pauli-Z), the controlled gates, the Hadamard gate, the phase shift gates, the swap gate, the Toffoli gate, etc. A quantum circuit can be constructed based on a set of parameter values (e.g., a vector of parameter values), θ={θ₁, θ₂, . . . θₙ}, to create a wavefunction (e.g., |ψ(θ) [symbol] ). For example, the set of parameter values can include a set of rotation angles that define the rotation of a qubit around axes (e.g., X, Y and Z axes). More specifically, a set of parameter values can define parameters of quantum gates used to construct parameterized gates of the quantum circuit. For example, a wavefunction with n qubits can be represented by |ψ(θ) [symbol] =U(θ)|0 [symbol] , where |0 [symbol] represents the “0” state, U(θ) is a unitary operator representing the quantum circuit or a sequence of quantum gates parameterized by θ, and the symbol ⊗ represents the tensor product. The other state can be the “1” state, represented by |1 [symbol] .

In classical information theory, a “classical communication channel” (or “classical channel”) refers to a medium for transmitting classical information from a sender to a receiver. In quantum information theory, a “quantum communication channel (or “quantum channel”) refers to a communication pathway capable of transmitting quantum information, which is inherently encoded in a quantum state of a quantum system (e.g., in a qubit). The evolution of a quantum state within a quantum channel can be described by a mapping from the quantum state to another quantum state. Conceptually, a quantum channel can be viewed as a pathway designed for the reliable transmission between locations. For example, a quantum channel can be used to transmit encoded information about a quantum state of a quantum system (e.g., via a qubit). More precisely, a quantum channel serves as a framework to describe how the quantum state of a system evolves over time, including the effects of noise and decoherence that pose challenges in practical quantum computing. The behavior and properties of a quantum channel can be dictated by quantum mechanical principles, such as the superposition of quantum states and quantum entanglement between multiple quantum systems. These quantum mechanical principles enable unique and powerful functionalities that are simply not achievable using classical communication channels or computational methods. Quantum channels can be used to enable quantum communication protocols. For example, a quantum channel may support quantum teleportation to enable the transmission of an arbitrary quantum state from one physical location to another, potentially across vast distances, without the need for the physical transfer of the particle or qubit that carries the state.

Broadly speaking, any discrete time change in the state of a quantum system that adheres to the fundamental principles of quantum mechanics can be fully described by a quantum channel. In particular, a quantum channel can be mathematically represented by a linear transformation of an input density matrix representing at least one quantum state of a quantum system, to an output density matrix representing the evolution of the at least one quantum state. For example, a quantum channel can be represented using a combination of linear operators in an operator-sum framework, also known as Kraus operators. The minimum number of Kraus operators used to represent a quantum channel is defined as its Kraus rank. A quantum channel that can be represented by only one Kraus operator (i.e., a quantum channel having a Kraus rank of 1) is referred to as a pure quantum channel. In this case, the evolution of the quantum state can be described by a single, deterministic operation, such as a unitary transformation, without any probabilistic mixing or noise. The operator-sum framework can be used to capture the complex effects of noise, energy dissipation, and other interactions that a quantum state might experience through a quantum channel. To maintain consistency with quantum mechanical principles, a quantum channel can be defined by a completely positive (CP) and trace-preserving (TP) linear map (CPTP linear map). The CP property means that the transformation not only maps any valid quantum state to another valid quantum state, but also ensures that this remains true even when the quantum system is considered as part of a larger system (e.g., a subsystem of a larger quantum entangled system). The TP property ensures that the total probability associated with any quantum state is conserved after the transformation (i.e., the probability remains exactly one). Accordingly, the CP property guarantees that the output of the channel is always a physically possible quantum state, while the TP property guarantees that no probability is lost or gained during the evolution of the quantum state through the quantum channel.

One example of a quantum channel is a unitary quantum channel, which reflects the application of a quantum gate to a quantum state. Mathematically, if the quantum state is represented by a density matrix ρ and the quantum gate by a unitary operator U, then the quantum state after passing through the unitary quantum channel is given by ρ′=UρU^{†}. This process is reversible and, in the absence of any interaction with the environment, represents noise-free evolution of the quantum state. Unitary quantum channels characterize the time evolution of closed quantum systems, where there is no exchange of energy or information with the surroundings, and serve as the idealized building blocks for quantum computations. For example, a perfect quantum channel that transmits any input quantum state without alteration can be represented by a unitary channel, where the unitary operator U is the identity operator (I), such that ρ′=IρI^{†}=ρ.

Quantum channels may be used as transmission media in quantum computing systems, such as to connect different quantum computing devices, different components of a quantum system, and so on. A quantum channel can transmit quantum information (such as qubits), as well as classical information, from one location to another.

Some quantum channels associated with quantum circuits of quantum computers can be noisy. For example, data transmitted via a quantum channel can experience dissipation or other types of noise, making the quantum channel a so-called “noisy” quantum channel. A noisy quantum channel is typically modeled as a non-unitary channel, meaning it does not preserve the original quantum state data (e.g., the density matrix) transmitted from a sender to a receiver. Instead, noise alters the quantum state during transmission, which can lead to errors. Noise refers to any interaction with the environment that causes the quantum state to deviate from its intended evolution. This includes factors such as decoherence (loss of quantum information), imperfect control of quantum gates, or interactions with other quantum systems. Noise in the quantum channel can arise from various sources, including imperfect control operations, environmental interactions, and hardware limitations, all of which can significantly degrade the accuracy of quantum computations. For instance, noise can introduce errors in the measurement of observables (such as energy levels) of a quantum system, as determined by a quantum circuit executed on a quantum computer. Even minor environmental disturbances—such as stray magnetic or electric fields, thermal fluctuations, or unintended interactions with other particles or qubits—can significantly perturb the quantum state.

Noisy quantum channels can act asymmetrically on quantum systems, such as through bit-flip noise, phase-flip noise, amplitude-damping noise, and other asymmetric noise processes. However, a sequence of such random, asymmetric noise processes can, in aggregate, yield an effectively symmetric noise model—the depolarizing channel. The depolarizing channel may be considered universal because it erases quantum information regardless of the input, driving quantum states toward the maximally mixed state. Owing to this symmetric decoherence dynamics, the resulting process can be modeled as a quantum diffusion model in embodiments. In at least one embodiment, such symmetric noise models also arise in quantum state reconstruction, including quantum tomography and classical shadows. In these settings, the measurement process (e.g., a Positive-Operator Valued Measure (POVM), together with device imperfections, induces decoherence. Moreover, randomized measurements and twirling often render the effective noise approximately depolarizing. In at least one embodiment, when the effective noise is only approximately depolarizing—that is, when the true channel deviates from an ideal depolarizing map—identifying it accurately enough for inversion becomes challenging. In such cases, channel-agnostic or robust mitigation methods may be preferable to exact inversion.

When noise is present, it can cause information loss, incorrect manipulation of qubits during quantum logic operations (such as unintended rotations or faulty gate applications), and other operational errors. The likelihood and severity of these errors can increase as the size and complexity of the quantum computer grows, due to the greater number of qubits and operations involved. For example, noise can gradually degrade or erase the quantum information (e.g., encoded in the qubits), leading to a loss of quantum state coherence and fidelity. This corruption of quantum data can result in the accumulation of errors in quantum computations and communications. Over time, these accumulated errors can cause the transmitted quantum state to completely deviate from the original state (e.g., through decoherence). This presents a significant challenge for achieving reliable quantum computation and highlights the need for effective error mitigation (e.g., error correction) techniques to address errors caused by transmission through noisy quantum channels.

Embodiments described herein can address these and other drawbacks by implementing noisy quantum channel error mitigation by training a machine learning model to map noisy quantum state information to an original, noise-free quantum state. Embodiments described herein are also related to the transfer of optical qubits over long distances, cleaning a quantum state before it goes to the next quantum computing system.

Physical implementation of the quantum channel 115A may involve varied environmental temperature regimes, each characterized by distinct noise profiles. While optical qubits may operate within room-temperature links, qubits operating at cryogenic temperatures present specific challenges when coupled directly to a system interconnect such as NVIDIA® NVLink™. Cryogenic quantum systems typically operate at temperatures near absolute zero (e.g., millikelvin ranges for superconducting qubits), and direct coupling to room-temperature interconnects introduces a significant thermal gradient that can induce decoherence and information loss. The interface between cryogenic quantum hardware and room-temperature interconnect infrastructure represents a critical juncture where quantum state degradation may occur due to thermal noise injection, impedance mismatches, and electromagnetic interference from the warmer environment. Transmission through room-temperature media from a cryogenic source may inject additional thermal noise, necessitating a higher number of repetitions and more intensive purification within the machine learning model to restore the original quantum information. In at least one embodiment, the interconnect (e.g., NVLink) serves as both the transmission medium and the location where error mitigation operations are performed. Rather than functioning as a passive conduit, the interconnect infrastructure may incorporate the trained machine learning model to identify noise types introduced during the cryogenic-to-room-temperature transition and simulate the inverse quantum channel in situ. This integration enables the interconnect hardware to autonomously restore the integrity of transmitted quantum messages before they reach the computational layers of a receiving processing node, effectively performing quantum state cleaning at the interconnect level. The NVLink or similar high-bandwidth interconnect may thus serve a dual role: facilitating high-speed data transfer between quantum and classical processing components while simultaneously implementing real-time error mitigation protocols that compensate for the thermal noise accumulated during computations performed by a cryogenic quantum system, and data transmission from the cryogenic quantum system.

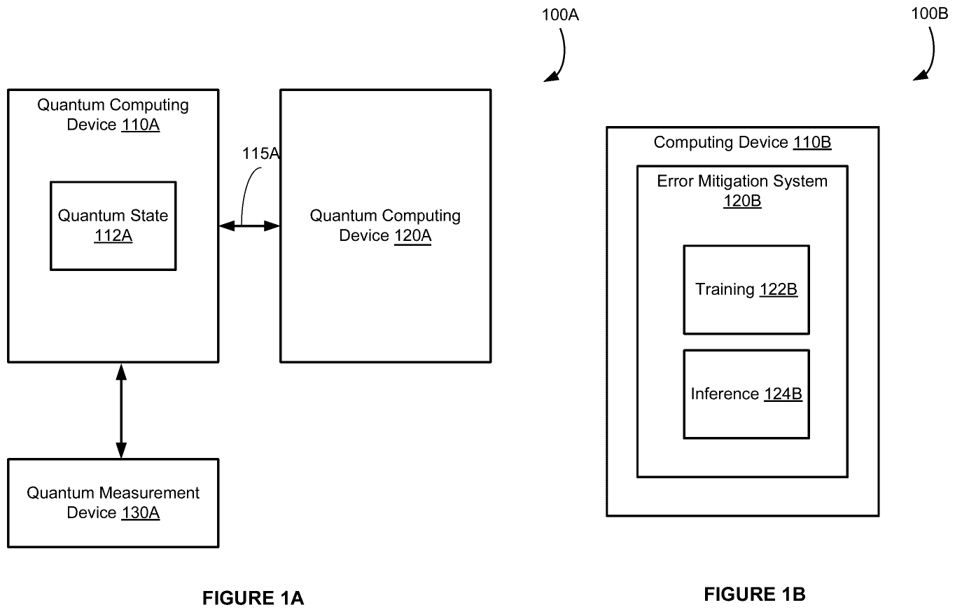

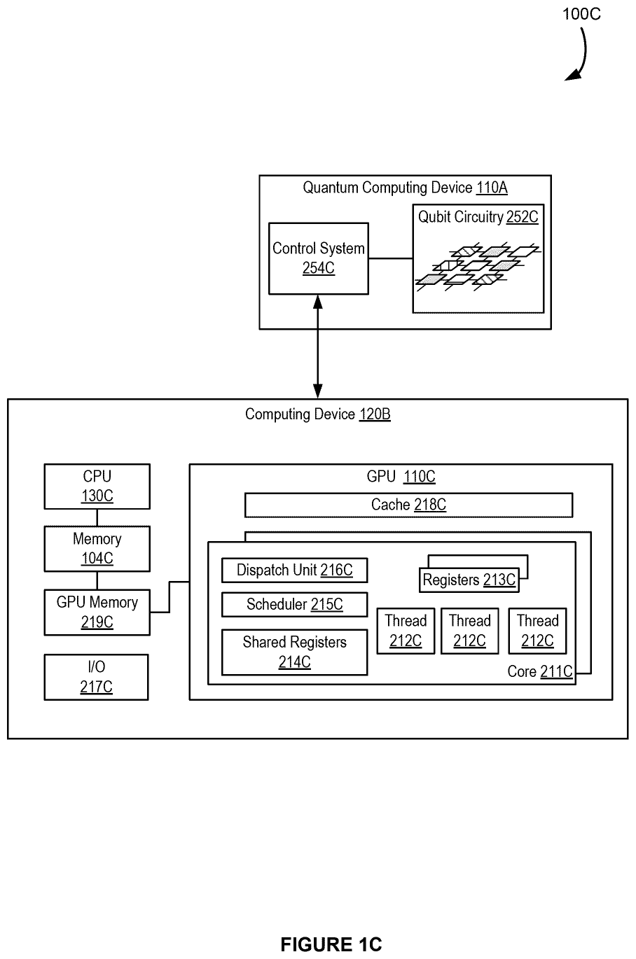

The present techniques may utilize weak measurements (e.g. mid-circuit weak measurements) to simulate a noisy quantum channel, and thus generate training data for training a machine learning model to perform noisy quantum channel error mitigation. A “weak” measurement refers to a measurement that only slightly disturbs a quantum system, as opposed to a “strong” measurement that completely disturbs the quantum system (e.g., collapses a wave function). The weak measurements may be used to create any type of noisy quantum channel. This can be achieved by performing many weak measurements to create artificial noisy quantum channels. The measurement strength can be tuned, allowing for the measurement of any type of property and the creation of any type of noisy channel. The trained machine learning model can then be used to perform error mitigation. A machine learning model described herein can be trained to recover an original quantum state by removing noise introduced by a noisy quantum channel, and thus approximate an inverse quantum channel. The machine learning model described herein can be used to identify at least one noise type added by at least one non-unitary quantum channel. In at least one embodiment, a machine learning model is a diffusion model. Further details regarding implementing noisy quantum channel error mitigation will be described below with reference to FIGS. 1A-13B.

The trained machine learning model can be deployed in real quantum computing systems or experimental setups to perform error mitigation protocols (e.g., in situ cutting-edge error mitigation protocol) providing more accurate and reliable data for training the model. In at least one embodiment, the training process utilizes both simulated and non-simulated (experimental) data, allowing the machine learning model to learn from real-world noise characteristics and operational imperfections. This approach can result in more robust and effective error mitigation protocols that are better suited to practical quantum computing environments.

Embodiments described herein can be used in various quantum computing applications. Examples of quantum computing applications include error mitigation, secure quantum communication, quantum teleportation, quantum key distribution, quantum sensing and metrology, quantum simulation, and distributed quantum computing, among others. The output of the machine learning models described herein, which includes output data indicative of an original quantum state recovered from noisy input data, can be utilized in each of these applications to improve performance and reliability.

For example, in error mitigation applications, the output of the machine learning model representing the denoised quantum state can be used to increase tolerance to various types of noise introduced by non-unitary quantum channels, such as depolarizing noise, amplitude damping noise, and phase damping noise, among others. The recovered quantum state output can replace the corrupted quantum state in subsequent quantum computations, which may reduce the accumulation of errors during quantum algorithm execution.

In secure quantum communication applications, the output of the machine learning model can be used to reconstruct the original quantum state of transmitted qubits, thereby enhancing the fidelity of quantum states transmitted between parties and improving the reliability of quantum cryptographic protocols. The denoised quantum state output enables more robust quantum key distribution over longer distances by correcting for channel-induced errors before key extraction.

In quantum teleportation applications, the output of the machine learning model can be used to correct the received quantum state after teleportation, improving the accuracy of quantum state transfer between spatially separated quantum systems by removing noise accumulated during the teleportation process. The corrected quantum state output can then be used for subsequent quantum operations at the receiving node.

In quantum sensing and metrology applications, the output of the machine learning model can be used to remove noise-induced errors from quantum sensor outputs. The denoised quantum state output provides a more accurate representation of the measured physical quantity.

In quantum simulation applications, the output of the machine learning model can be used to correct the quantum states of simulated systems, improving the accuracy of simulated quantum systems by correcting for hardware-induced errors and enabling more reliable modeling of complex molecular structures, material properties, and chemical reactions. The error-mitigated quantum state output can be used to extract more accurate expectation values and observables from the simulation. In distributed quantum computing applications, the output of the machine learning model can be used to recover the original quantum states transmitted between quantum processing nodes connected via noisy quantum channels, facilitating reliable communication and enabling the construction of larger-scale quantum computing systems from smaller, interconnected quantum processors. The denoised quantum state output at each receiving node ensures that subsequent distributed quantum operations proceed with high-fidelity quantum data.

Systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., raytracing, path tracing, etc.), collaborative content creation for 3D assets, generative AI operations using (e.g., large) language models, cloud computing and/or any other suitable applications. The systems and methods described herein may be used in a system for compiling a quantum circuit, a system for executing a quantum circuit, a system for measuring a quantum state, and/or a system for measuring a state of a qubit or qubits.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations using (large) language models, systems for performing light transport simulation, systems for performing collaborative content creation for 3D assets, systems implemented at least partially using cloud computing resources, and/or other types of systems.

In at least one embodiment, a resulting machine learning model can be integrated into hybrid quantum-classical workflows. For example, a machine learning model may be integrated via a communication interface (e.g., a QLink-type interface) with quantum computing systems. In addition to error mitigation, a machine learning model may have a role in state preparation (e.g., generating target quantum states from noise). Applications may include embedding these models more efficiently into quantum algorithms such as Variational Quantum Linear Solver (VQLS). In at least one embodiment, a machine learning model is configured to manage resources effectively in the presence of mid-circuit measurements. The integration of error mitigation models into hybrid quantum-classical workflows may enable more reliable quantum computations by correcting errors introduced during quantum algorithm execution. In at least one embodiment, classical computational resources support quantum algorithms through post-processing that stabilizes their outputs. Although the target evolution in a quantum algorithm is unitary, noise effectively turns it into a general noisy channel. The machine learning models described herein can help mitigate this noise, enabling the hybrid quantum-classical system to achieve higher fidelity results.

In at least one embodiment, improved error mitigation as described herein reduces the number of sampling runs required on a quantum computer. Because the sampling requirements depend on the purity of the quantum circuit, a noisier circuit requires more runs to obtain statistically accurate results. By training machine learning models using the protocols described herein—such as by dividing a communication line into small segments where the noise in each segment resembles a weak measurement—the performance of error mitigation may be improved. As a result, fewer processor cycles on the quantum computer may be needed, which may translate to lower power consumption and greater bandwidth, or the ability to use qubits for other tasks. Additionally, effective error mitigation may reduce or eliminate the need for other error correction protocols that require additional qubits, which may not be available in resource-constrained quantum systems.

In at least one embodiment, the techniques described herein provide several technical advantages. In at least one embodiment, training a machine learning model to simulate an inverse of a non-unitary quantum channel may improve error mitigation performance by enabling recovery of quantum states corrupted by noise without requiring exact knowledge of the noise channel. Improved error mitigation may reduce the number of sampling runs required on a quantum computer, resulting in fewer processor cycles, lower power consumption, and greater bandwidth, or the ability to use qubits for other tasks. Effective error mitigation may also reduce or eliminate the need for other error correction protocols that require additional qubits, which may not be available in resource-constrained quantum systems. In at least one embodiment, dividing a communication line into small segments where the noise in each segment resembles a weak measurement may improve error mitigation performance. In at least one embodiment, channel-agnostic mitigation methods may be used when the effective noise only approximately matches a depolarizing channel, avoiding the need to accurately characterize the channel for direct inversion. In at least one embodiment, attention mechanisms may capture non-local quantum correlations, such as entanglement between distant qubits, that cannot be adequately captured by purely convolutional operations with spatially limited receptive fields. In at least one embodiment, applying attention at a reduced resolution bottleneck rather than at full input resolution may reduce the quadratic computational cost of attention while still enabling the model to learn global dependencies. In at least one embodiment, the techniques described herein may scale across different quantum register types, including separable quantum registers where features scale linearly with the number of qubits and entangled quantum registers where features scale exponentially, with attention-based models handling entangled quantum registers more efficiently than recurrent neural network models. In at least one embodiment, a machine learning model may be trained using only local density matrices to reconstruct global quantum states, enabling reconstruction from limited input information. In at least one embodiment, average pooling may preserve phase information in quantum state representations by retaining the aggregate signal energy of all features rather than selectively retaining only maximum activations. In at least one embodiment, blind denoising may be performed without explicit noise-level conditioning, enabling generalization across different noise levels. In at least one embodiment, training stability may be improved through teacher forcing with gradual transition to autoregressive generation, mixed-precision arithmetic, exponential moving average of model weights, and gradient clipping. In at least one embodiment, a trained machine learning model may be used for both error mitigation and state preparation, providing flexibility in quantum computing applications. In at least one embodiment, the techniques described herein may be integrated with hybrid quantum-classical workflows, including variational quantum algorithms such as VQLS, and may manage resources effectively in the presence of mid-circuit measurements. In at least one embodiment, tensor network representations may enable graphics processing unit (GPU)-efficient implementation for rapid generation of training data.

In the following and preceding description, numerous specific details are set forth to provide a more thorough understanding of at least one embodiment. However, it will be apparent to one skilled in the art that the inventive concepts may be practiced without one or more of these specific details. Following figures set forth, without limitation, example systems and methods that implement collective communication protocols for quantum metrology.

FIG. 1A is a block diagram illustrating a system 100A, in accordance with at least one embodiment. As shown in FIG. 1, the system 100A can include a quantum computing device 110A communicably coupled via a quantum channel 115A to a quantum computing device 120A.

In at least one embodiment, the quantum channel 115A corresponds to an interconnect. For example, an interconnect can enable communication between one or more processing units of the quantum computing device 110A and one or more processing units of the quantum computing device 120A. The interconnect may be physically reconfigured, such as by rewiring, to apply transformations without active measurement. In at least one embodiment, the interconnect or quantum channel 115A may be physically reconfigured to manipulate quantum state trajectories. For example, a physical adaptation of the interconnect, such as ‘rewiring the cable,’ may be employed to transform a trajectory of one or more poles within a quantum state without necessitating active measurement. Such hardware-level reconfiguration allows for the application of specific transformations or noise-mitigation protocols by physically altering the transmission path. The interconnect (e.g., NVLink) and the network interface card (NIC) serve as primary functional actors in the error mitigation protocol, acting as the mediums where both quantum state transmission and ‘cleaning’ occur. Rather than acting as a passive conduit, the NIC and system-level interconnects may incorporate the trained machine learning model to identify noise types added during transmission and simulate the inverse quantum channel in situ. This integration may enable the interconnect hardware to autonomously restore the integrity of transmitted quantum messages before they reach the computational layers of a receiving processing node.

The quantum computing device 110A can transmit a quantum state 112A of a quantum system to the quantum computing device 120A via the quantum channel 115A. More specifically, the quantum state 112A can represent an original quantum state of the quantum system. In at least one embodiment, the quantum channel 115A is a noisy quantum channel that introduces noise into the quantum state 112A. More specifically, a noisy quantum channel can be any suitable non-unitary quantum channel in accordance with embodiments described herein. One example of a non-unitary quantum channel is a depolarizing channel. A depolarizing channel can be used to model depolarizing noise. For example, a unit of quantum information (such as a qubit) retains its quantum state with probability p, and with probability 1-p, it loses all quantum information. In the latter case, the quantum state 112A is transformed into a maximally mixed state, represented by the identity operator I divided by the dimension of the Hilbert space associated with the quantum system (for example, I/2 for a qubit).

Another example of a non-unitary quantum channel is an amplitude damping channel. An amplitude damping channel can be used to model the process by which a unit of quantum information (e.g., a qubit) loses energy to its environment with a certain amplitude damping probability, potentially causing a transition from the excited state to the ground state.

Another example of a non-unitary quantum channel is a phase damping channel. A phase damping channel can be used to model the loss of quantum information due to random phase fluctuations, without any exchange of energy with the environment.

Another example of a non-unitary quantum channel is a bit-flip channel. A bit-flip channel can be used to flip the state of a qubit from |0 [symbol] to |1 [symbol] or vice versa with a certain probability p. As will now be described below with reference to FIG. 1B, an error mitigation system implementing noisy quantum channel error mitigation may be used to recover an initial or original quantum state that has been impacted by noise caused by the quantum channel 115A.

FIG. 1B is a block diagram illustrating a system 100B for implementing noisy quantum channel error mitigation, in accordance with at least one embodiment. In at least one embodiment, and as shown in FIG. 1B, the system 100B includes a computing device 110B that includes an error mitigation system 120B implementing noisy quantum channel error mitigation. In at least one embodiment, the computing device 120B is a classical computing device. In at least one embodiment, the computing device 120B is a quantum computing device. In other embodiments, at least one component of the error mitigation system 120B is located in a separate computing device or system.

The error mitigation system 120B can perform noisy quantum channel error mitigation. In particular, noisy quantum channel error mitigation as described herein can be achieved by training a machine learning model to map noisy quantum information to its corresponding ideal (noise-free) quantum state.

For example, the error mitigation system 120B can include a training component 122B. The training component 122B can train a machine learning model during a training stage to approximate the inverse of a noisy quantum channel that removes noise introduced by a noisy quantum channel. In at least one embodiment, the training process utilizes both simulated and non-simulated (experimental) data, allowing the machine learning model to learn from real-world noise characteristics and operational imperfections. This approach can result in more robust and effective error mitigation protocols that are better suited to practical quantum computing environments. The trained machine learning model can be deployed in real quantum computing systems, hybrid computing systems that include both quantum computing components and traditional computing components, and/or experimental setups to perform error mitigation protocols in situ. Additionally or alternatively, the error mitigation system can include an inference component 124B. The inference component 124B can, during an inference stage, use a trained machine learning model to recover the quantum state 112A. Accordingly, the error mitigation system 120B may receive input data generated by processing one or more physical signals (e.g., optical signals, electrical signals, and/or microwave signals).

The input data may be indicative of the quantum state 112A (sent by the quantum computing device 110) that is modified by an amount of noise added by the quantum channel 115A. The error mitigation system 120B can provide the input data to a machine learning model trained by the training component 122B to predict the quantum state 112A by simulating an inverse of the quantum channel 115A, and obtain, from the machine learning model via the inference component 124B, output data indicative of the quantum state A.

In at least one embodiment, the machine learning model is a generative model trained to predict and reconstruct an original quantum state (e.g., the quantum state 112A) from input data, thereby generating the original quantum state as an output. For example, the machine learning model can be a diffusion model, which is a class of generative models designed to iteratively denoise input data. In general, a diffusion model is trained to generate output data by learning to remove noise that has been systematically added to the input data. This makes diffusion models particularly suitable for recovering corrupted or noisy data, such as quantum state data impacted by noise due to transmission through a noisy quantum channel.

If the machine learning model is a diffusion model, training the machine learning model during the training stage using the training component 122B typically involves two main processes: a forward diffusion process and a reverse diffusion process. In the forward diffusion process, random noise is progressively added to the data over a series of discrete time steps, such that the data transitions from its original form to a state of nearly pure noise. Each step in the forward diffusion process depends on the previous step. For example, the forward diffusion process can be mathematically modeled as a Markov chain, where the probability distribution of the data at each step depends only on the immediately preceding step. The reverse diffusion process is then learned by the diffusion model during training. In this process, the model is trained to reverse the effects of the forward diffusion process, step by step, by predicting and removing the noise that was added at each step. The objective of the reverse diffusion process is for the model to reconstruct noise-free data from the noisy input. Using a trained machine learning model during the inference stage using the inference component 124B can include receiving input data that represents a noisy or corrupted quantum state (or even pure random noise), and iteratively applying the learned reverse diffusion process to generate output data that approximates the original (denoised) quantum state. Thus, the output quantum state data produced by the trained diffusion model corresponds to a predicted, noise-corrected version of the input quantum state data, enabling a practical implementation of effective quantum data error mitigation.

In at least one embodiment, a machine learning model (e.g., a diffusion model) is implemented using a recurrent neural network (RNN)-based architecture. RNNs are neural networks designed to process sequential data by maintaining internal hidden states that capture information from previous time steps. This makes them well-suited for tasks involving temporal or sequential dependencies, such as time series prediction, speech recognition, and video analysis. In the context of quantum systems, RNNs can be particularly advantageous when modeling noisy quantum channels that can be represented as a sequence of weak measurements, where each measurement provides partial information about the quantum state.

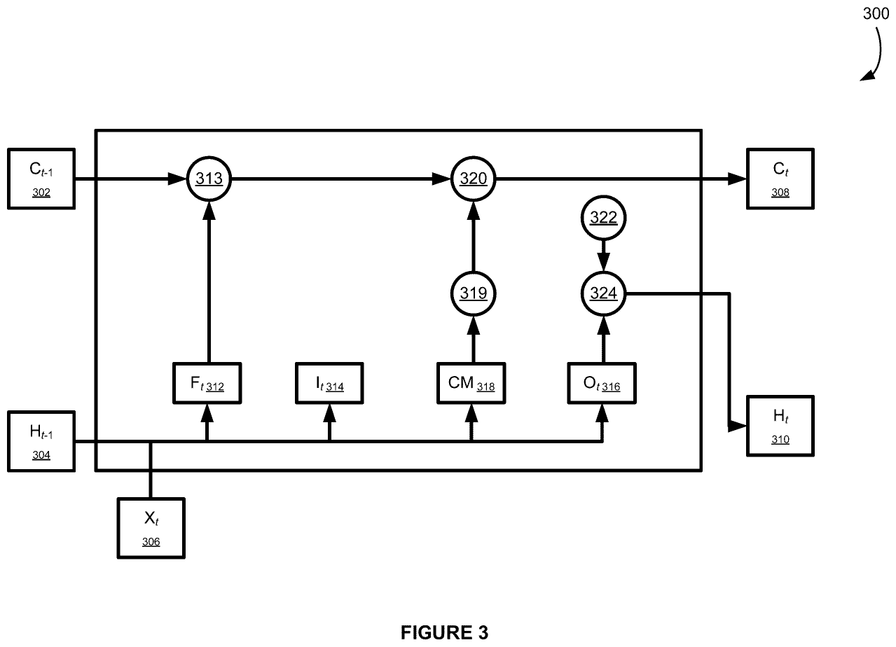

One type of RNN that can be used is the long short-term memory network (LSTM). LSTMs are designed to capture both short-term and long-term dependencies in sequential data through a system of gates, referred to as input, forget, and output gates, and a cell state that acts as a memory. These gates regulate the flow of information, allowing the network to selectively retain or discard information over time. An LSTM can be structured with main layers and hidden layers: the main layers are responsible for capturing long-term correlations (e.g., relationships between initial quantum states across sequences), while the hidden layers capture short-term correlations (e.g., changes between consecutive time steps or measurements). In at least one embodiment, the LSTM architecture features a multi-layer encoder followed by a residual feedforward network, with hidden layers propagated through time steps to capture temporal correlations, allowing for autoregressive predictions. In this framework, the short-term correlations modeled by the hidden layers can be used to represent the dissipation or evolution of quantum states over a sequence of weak measurements. The long-term correlations captured by the main layers can be used to relate these sequences to a reference scenario, such as the evolution of a quantum state toward the maximally mixed state (i.e., the state in which the quantum system is in a completely random mixture of all possible basis states). The maximally mixed state has maximum entropy and no information about the initial quantum state is retained. This dual-level modeling enables the LSTM to learn both the immediate effects of individual weak measurements and the overall trajectory of the quantum state, providing a comprehensive approach to reconstructing or denoising quantum states from weak measurement data. An example RNN (e.g., LSTM) that can be used to implement a machine learning model for noisy quantum channel error mitigation is described below with reference to FIG. 3.

One technical challenge in the error mitigation system 120B implementing noisy quantum channel error mitigation using a machine learning model (such as a diffusion model) is the potential lack of sufficient and representative training data required for effective training. To address this issue, the error mitigation system 120B can use a process to generate synthetic training data specifically tailored for training a machine learning model to perform noisy quantum channel error mitigation. This process can involve generating multiple random pure quantum states, for example, by applying random unitary matrices to a fixed reference state (such as the ground state). Each generated pure state can then be transmitted through a randomly selected quantum channel, which may be characterized by a specific type of quantum channel (e.g., depolarizing, amplitude damping, or phase damping channel). The output, or the resulting noisy quantum state after transmission, is recorded along with the corresponding original pure state. This pair of data-including the noisy output and the known original input-serves as a training example. By repeating this process for a sufficiently large number of random pure states and random quantum channels, a comprehensive training dataset can be constructed. This dataset can then be used to train a machine learning model, such as a diffusion model, to learn the mapping from a noisy quantum state to a corresponding denoised quantum state, thereby enabling the model to perform effective quantum data error mitigation.

In at least one embodiment, generating training data includes performing “weak” measurements on the quantum computing device 110 using a quantum measurement device 130. A weak measurement is a type of quantum measurement that only minimally disturbs the quantum state 112A, such as by only partially collapsing the wave function. This is in contrast to a “strong” measurement, which is a type of quantum measurement that fully collapses the wave function and completely disturbs the quantum state 112A. In a weak measurement, the quantum state 112A is only partially projected onto the quantum measurement device 130, meaning that the measurement outcome provides limited information about a measured observable. As a result, the quantum state 112A after a weak measurement can become partially noisy, with the degree of noise depending on the specific observable being measured and the strength of the measurement interaction, the properties being measured can include magnetic fields in different bases (X, Y, Z). The noise induced depends on the basis being measured. The effect of the measurement on the quantum state depends on the state itself. For example, measuring spin Z on a spin Z state induces no noise, while measuring spin Z on a spin X state deletes information. Additionally, weak measurements can yield so-called “anomalous values,” which are measurement outcomes that may fall outside the expected range of eigenvalues for the measured observable. Additionally, by generating multiple weak measurements in sequence, a quantum state may deviate further and further from an original state in an observable manner.

Due to these properties of weak measurements, they can be used as training data that simulates the effects of a noisy quantum channel by introducing controlled, incremental noise into the quantum computing device 110, while still preserving at least some information about the quantum state 112A. In particular, the training component 122B can train a machine learning model (e.g., a diffusion model) to perform error mitigation for noisy quantum channels by removing noise from data generated by one or more weak measurements. Since a single weak measurement typically provides limited information about the quantum state 112A, multiple weak measurements-possibly performed on a single quantum system or identically prepared quantum systems including the quantum computing device 110—can be combined (e.g., through statistical averaging or data fusion techniques) to extract more accurate and meaningful information about the quantum state 112A. Furthermore, weak measurements can be used in conjunction with pre-selection (preparing the quantum system in a known initial state) and post-selection (selecting a specific final state after the weak measurement). The inference component 124B can use such a trained machine learning model to remove noise from data resulting from one or more weak measurements of a quantum system modeling noise. For example, a single weak measurement, or a sequence of weak measurements, can be provided as input to the trained machine learning model, which then predicts the quantum state 112A from the input and reconstructs the quantum state 112A as output.

As an illustrative example of training by the training component 122B, a machine learning model described herein (e.g., an LSTM model) can be trained, using appropriate training data, to predict the backward evolution of each density matrix that has been used to simulate a noisy quantum channel. By predicting the backward evolution of each density matrix, the machine learning model can identify the corresponding inverse quantum channel that effectively removes the noise introduced by the noisy quantum channel. During an initial stage of this training, the machine learning model can be exposed to an unknown quantum channel constructed using a set of random elements, such as random Positive-Operator Valued Measure (POVM) elements, which are applied as weak projections on a randomly chosen quantum state. This initial quantum state is designated as a prime example. A control system can repeatedly apply these measurements with constant interaction strength to the prime example, driving its evolution until the quantum state approaches the maximally mixed state. Once the maximally mixed state is reached or closely approximated, the control system can halt the measurements and record the entire sequence of density matrices representing the state's evolution, assuming the density matrices have been reconstructed at each step (e.g., by performing quantum state tomography or other suitable technique). Following this initial stage, additional pure quantum states, which can be correlated with the prime example via unitary rotations, can be input into the same unknown quantum channel. The evolution of their respective density matrices can be monitored and recorded in a similar manner. Unlike the prime example, these additional quantum states may not necessarily reach the maximally mixed state, as their final states depend on both the interaction strength and the number of measurements applied. The machine learning model can be trained to analyze the evolution of these various examples, enable it to learn the characteristics and structure of the underlying quantum channel. As an illustrative example of inference by the inference component 124B, a trained machine learning model can be used to identify an inverse quantum channel that can transform the maximally mixed state of the prime example back into its original pure state. This approach enables the reconstruction or denoising of noisy quantum states. In at least one embodiment, at least two quantum channels are sequentially combined to form a composite quantum channel. This framework can be further generalized to high-dimensional Hilbert spaces, allowing the machine learning model to handle quantum systems with larger state spaces and more complex noise processes.

In at least one embodiment, the forward diffusion process uses a Pauli-6 POVM as a set of quantum instruments to create the noisy quantum channel. In the Pauli-6 POVM, each projection has the same measurement strength but may affect each density matrix differently depending on the quantum state. The explicit form of the Pauli-6 POVM may be defined with an operator sum representation. In at least one embodiment, other POVM sets may be used, such as a SIC (Symmetric Informationally Complete) POVM or any other suitable set of measurement operators. The choice of POVM set may affect the characteristics of the resulting noisy quantum channel and the training data generated for the machine learning model.

In at least one embodiment, a machine learning model (e.g., a diffusion model) is implemented using an encoder-decoder architecture with multi-head attention mechanisms. Unlike convolutional neural networks (CNNs), which primarily capture local spatial dependencies through limited receptive fields, or LSTMs, which excel at sequential dependencies but may not efficiently model spatial correlations, attention mechanisms can identify dependencies between arbitrarily distant spatial locations. This capability is particularly advantageous for quantum state representations, as quantum states can exhibit non-local correlations (e.g., entanglement between distant qubits) that cannot be adequately captured by purely convolutional operations with spatially limited receptive fields. In at least one embodiment, multi-head self-attention is integrated at the bottleneck of an encoder-decoder architecture to capture non-local quantum correlations. The architecture may comprise three main components: an encoder path that progressively reduces spatial dimensions while increasing feature channels, an attention-based bottleneck that captures long-range spatial dependencies, and a decoder path that reconstructs the denoised state at the original resolution. An example vision transformer architecture that can be used to implement noisy quantum data error mitigation is described below with reference to FIG. 16.

In at least one embodiment, a machine learning model is implemented using a U-Net architecture. The encoder may comprise residual blocks operating at progressively reduced spatial resolutions, with channel dimensions expanding at each stage. In at least one embodiment, the downsampling operation may employ average pooling. Average pooling may be chosen over max pooling because it may preserve the aggregate signal energy of all features in each pooling window, whereas max pooling may selectively retain only the maximum activation. For quantum state representations, where phase information may be encoded across multiple spatial features, preserving all signal contributions may be beneficial for maintaining the coherent structure of the quantum state. In at least one embodiment, the residual blocks employ a pre-activation design with Group Normalization and SiLU (Swish) activation functions, followed by convolutions with reflection padding. The pre-activation residual design (normalize→activate→convolve) may facilitate gradient flow in deep networks by ensuring that gradients can propagate through clean additive paths without being modulated by activation functions. At the lowest spatial resolution (the bottleneck), a multi-head self-attention mechanism may be integrated to enable the model to capture global spatial correlations in the quantum state. The decoder may mirror the encoder structure, progressively reconstructing the spatial resolution through upsampling stages.

Skip connections may concatenate features from corresponding encoder layers with decoder features at each resolution level, preserving high-resolution spatial details and phase information that might otherwise be lost during the dimensionality reduction in the encoding process. The concatenated features may be processed through residual blocks that learn to selectively combine information from multiple scales: coarse semantic features from the decoder path and fine-grained details from the skip connections. In at least one embodiment, the hierarchical multi-scale architecture-which processes the input at multiple spatial resolutions simultaneously-combined with residual connections enables the model to learn adaptive denoising strategies. This adaptability may be beneficial for generalizing across different noise levels without explicit noise-level conditioning as an input, enabling blind denoising where the noise level is unknown at inference time.

The attention operation may scale quadratically with spatial resolution, expressed as O(N²) where Nis the number of spatial positions. By applying attention only at a reduced resolution bottleneck (e.g., 32×32 resolution with 1,024 positions) rather than at the full input resolution (e.g., 128×128=16,384 positions), the quadratic computational cost of attention may be reduced by a factor of 16 while still enabling the model to learn global dependencies.

In at least one embodiment, training a machine learning model includes using a teacher forcing strategy that transitions gradually to autoregressive generation. In the early stages of training, the model may receive the ground-truth target from the previous time step as input at each point in the sequence. This may accelerate convergence by exposing the model to ideal local inputs. However, reliance on ground truth during training can lead to a mismatch at inference time, when only the model's own predictions are available. To bridge this gap, a linear-plateau schedule may be used to anneal the teacher forcing probability. Over the course of training, the model increasingly relies on its own outputs from previous steps, adapting to the eventual inference-time scenario. This balance between teacher forcing and autonomous prediction may improve robustness and stability of the trained model.

In at least one embodiment, the machine learning model is trained by feeding it inverse sequences, thus training it to perform error mitigation at each time step. The training process may involve reversing simulated sequences to ensure that the ground truth corresponds to the previous (less noisy) states rather than the next (more noisy) ones, framing the task as a regression problem where the model predicts denoised quantum states step by step in an autoregressive manner.

In at least one embodiment, training a machine learning model leverages mixed-precision arithmetic (automatic mixed precision, AMP) for computational efficiency, exponential moving average (EMA) of model weights for improved generalization at test time, and gradient clipping to prevent instabilities during early training when the model encounters high-magnitude noisy inputs. In at least one embodiment, the model is optimized using an optimizer (e.g., Adam optimizer with weight decay or AdamW) with cosine annealing learning rate scheduling.

In at least one embodiment, training a machine learning model includes using a cost function based on mean squared error (MSE) with additional constraints. The cost function may include a trace normalization constraint that enforces Tr(ρ)=1, which forces the output density matrix to be normalized. The cost function may also include a penalty for non-Hermitian density matrices, taking into account the physicality of the generated quantum systems. In at least one embodiment, model performance is assessed using a geometrical fidelity metric that measures the overlap between predicted and target density matrices. To ensure that predicted outputs remain valid density matrices, post-processing may be applied to map them back to Hermitian forms, in accordance with the constraints of a CPTP map.

In at least one embodiment, in addition to error mitigation, a trained machine learning model can also be used for state preparation (e.g., generating target quantum states from noise). More specifically, after generating sufficient training data via the forward diffusion process, the trained model may act either as an error-mitigation protocol or as a state-preparation protocol. In the state preparation application, the model may be used to generate a target quantum state by providing an appropriate input and allowing the model to produce the target output state through the learned inverse dynamics.

In at least one embodiment, the forward diffusion process uses a Pauli-6 POVM as a set of quantum instruments to create the noisy quantum channel. In the Pauli-6 POVM, each projection has the same measurement strength but may affect each density matrix differently depending on the quantum state. The explicit form of the Pauli-6 POVM may be defined with an operator sum representation. In at least one embodiment, other POVM sets may be used, such as a SIC (Symmetric Informationally Complete) POVM or any other suitable set of measurement operators. The choice of POVM set may affect the characteristics of the resulting noisy quantum channel and the training data generated for the machine learning model.

In at least one embodiment, a machine learning model is trained using a Bloch vector representation for single-qubit error mitigation. In the Bloch sphere representation, a single qubit quantum state can be represented by a Bloch vector with three real-valued components. The Bloch vector dataset may have the shape [N, S, 3], where Nis the batch size (number of examples), S is the sequence length (number of noise steps), and 3 corresponds to the three Bloch vector components, which are all real numbers. In the notation of the Bloch vector, the more noisy the channel, the smaller the Bloch vector's norm becomes, approaching zero as the quantum state approaches the maximally mixed state. In at least one embodiment, each iteration of the forward diffusion process causes the Bloch vector to undergo an affine map transformation that changes the Bloch vector components. The inverse quantum channel may also be represented as an affine map that reverses this transformation.

Since the forward process is non-unitary, the inverse quantum channel may not be physical in the sense that entropy is decreasing. To make such a process physical and unitary in at least one embodiment, an ancillary quantum system is added according to the Stinespring dilation theorem. The Stinespring dilation theorem states that any CPTP map may be represented as a unitary operation on a larger Hilbert space that includes the original system and an ancillary quantum system, followed by a partial trace over the ancillary degrees of freedom. Here, the forward quantum channel may be understood as heating up the system in accordance with the second law of thermodynamics, while the inverse process cools down the system, similar to a purification process. The quantum channel has a non-physical inverse channel that may require dilation of the existing quantum system, often by using ancillary quantum states (e.g., ancillary qubits) that make the inverse process unitary and physically realizable. These ancillary quantum states are then discarded after the process. In the context of the Bloch vector representation described above, the inverse quantum channel can be represented as an affine map \vec{r}^{(t)}=\hat{M}⁻¹·(\vec{r}^{(t+1)}−\vec{t}), where \hat{M}⁻¹ is the inverse linear transformation matrix. However, this inverse transformation may amplify the Bloch vector beyond the unit sphere, which would correspond to a non-physical quantum state. In at least one embodiment, the machine learning model learns to approximate this non-physical inverse channel through classical post-processing, variational circuits, or measurement-conditioned maps. The inverse process is approximate and may be realized via classical post-processing that operates on measurement outcomes, variational quantum circuits that parameterize a family of quantum operations and optimize the parameters to approximate the inverse dynamics, or measurement-conditioned maps that apply different corrections based on intermediate measurement results. This approach progressively transforms noisy mixed states into estimates of their pre-noise pure states without requiring the exact physical implementation of the inverse channel, which would violate the second law of thermodynamics by decreasing entropy without coupling to an external system. Accordingly, in at least one embodiment, at least one processing device causes the quantum system to be coupled to an ancillary quantum system to implement a unitary operation that approximates the inverse of the non-unitary quantum channel, and a partial trace operation is performed over the ancillary quantum system.

In at least one embodiment, the training dataset has a specific shape notation that depends on whether the quantum register is separable or entangled. For separable quantum registers, the dataset shape may be [N, S, D, 2, 2], where Nis the number of examples (batch size), Sis the sequence length (number of noise steps), D is the number of qubits, and the 2×2 dimensions correspond to the real and imaginary components of each single-qubit density matrix. For entangled quantum registers, the dataset shape may be [N, S, 2^{D}, 2^{D}], reflecting that the matrices are much larger and contain many more parameters due to the exponential scaling of the Hilbert space dimension with the number of qubits. In at least one embodiment, when training on local density matrices for entangled registers, the input shape may be [N, S, D, 2, 2, 2], where the model sees each qubit independently without explicit correlations, but must output the initial correlated state of all qubits together as a single 2^{D}×2^{D} matrix. This demonstrates that the model can perform well even when input resources are limited.

In at least one embodiment, quantum states and quantum operations are represented using tensor networks. Tensor networks offer a compact graphical representation of quantum states, where nodes denote tensors and edges denote index contractions, making entanglement structure explicit. Tensor network representations may enable efficient methods for many-body simulations. In at least one embodiment, an input quantum state enters as a tensor and undergoes a sequence of CPTP maps, where each map is represented as a tensor block that acts at a labeled time step. The tensor network notation aligns with GPU-based computation and quantum mechanics for many-body systems, enabling efficient parallel processing of quantum state data. A tensor network representation may serve as a computational blueprint for GPU implementation, where the tensor network defines the structure of the quantum operations and noise channels, and the GPU enables parallel computation across multiple training examples. There are essentially two blueprint types corresponding to the two types of datasets: separable quantum registers and entangled quantum registers. Parameters may be randomly generated within this blueprint structure, and once the structure is defined, training examples can be generated very efficiently because everything is integrated on the GPU using the tensor network. This approach may enable rapid generation of large training datasets for the machine learning model. Further details regarding tensor networks are described herein.

A phenomenon that can arise from sequential weak measurements is the emergence of many mixed components that are projected onto different variants of the measurement projectors. As a result, reaching the maximally mixed state may become impossible in practice. Moreover, as the fidelity approaches that of the maximally mixed state, the process may become increasingly difficult, implying that the required sequence length grows extremely large when very small fidelity criteria are demanded. Therefore, in practical implementations, the fidelity threshold may be restricted to a feasible range. Fidelity requirements may be tuned. For example, a result may be considered purified at about 80%, at about 90%, or at about 100% fidelity depending on the algorithm. For global states composed of many qubits, the system may not be brought arbitrarily close to the global maximally mixed state. This practical limitation may affect the training data generation process and the design of the forward diffusion process.

FIG. 1C illustrates an example computing system 100C capable of supporting operations of noisy quantum channel error mitigation, according to at least one embodiment. In at least one embodiment, computing system 100C may include the quantum computing device 110A of FIG. 1A and the computing device 120B of FIG. 1B.

Qubit circuitry 252C may include multiple qubits (qutrits, qudits, etc.) implemented as two-state (three-state, d-state, etc.) physical systems. Qubit circuitry 252C may include arrays of Josephson junctions, trapped ions/atoms, quantum dots, electron spins, nuclear spins, diamond vacancies, coherent light states, topological electron states, magnetic flux states, and/or other quantum systems with a target dimensionality of Hilbert space, such as two-state Hilbert space in case of qubits (d-state Hilbert space, in case of qudits). Qubits in qubit circuitry 252C can be physically interacting with each other in a controllable way to implement quantum gates and realize quantum computations. Although in the schematic depiction of qubit circuitry 252C in FIG. 1C, each qubit is controllably coupled to four neighboring qubits (three or two qubits for edge or corner qubits, respectively), other topology of qubit circuitry 252C is possible, including non-rectangular topology, non-planar (e.g., three-dimensional) topology, and/or the like. A specific physical realization of qubit circuitry 252C and specific interaction (coupling) of the qubits with one another may depend on the type of quantum computing device 250C or the type of quantum computations that quantum computing device 250C is performing. Interaction of the qubits may be controlled by voltage (current) signals, microwave (or radio frequency) signals, controlled propagation through a medium (e.g., in case of light qubits), controlled exposure to magnetic fields (that causes precession of nuclear or electron spins), and/or the like.

Qubit circuitry 252C may further include readout circuitry that uses readout signals to probe states of the qubits, e.g., using microwave, radio frequency, optical signals, and/or other signals that depend on the specific physical type of the quantum computing device 110A.

Control and readout of states of qubit circuitry 252C may be performed by a control system 254C, which may include various components of a classical computer system that may be used to initiate states of the qubits, implement quantum gates, trigger readout measurements and implementation of error correction codes, storage of results of quantum computations, and/or to perform other operations as part of execution of a quantum circuit or algorithm. Control system 254C may include one or more classical processors, e.g. CPUs, GPUs, FPGAs, DPUs, ASICS, etc., one or more memory devices, input/output (I/O) units, which may be connected by one or more data buses. Control system 254C may further include digital-to-analog (DA) converters, analog-to-digital (AD) converters, electromagnetic signal generators, transmitters, receivers, filters, and/or other digital and/or analog devices. In one example, control system 254C may be programmed to generate a series of control signals for qubit circuitry 252C, e.g., to initialize a correct number of qubits for implementation of a desired quantum circuit, apply a selected set of quantum gates to the initialized qubits, generate readout signals, perform error correction operations, and/or the like.

Operations of software/firmware operating on (classical) computing device 120B may be executed using one or more GPUs 110C, one or more CPUs 130C, one or more parallel processing units (PPUs) or accelerators, such as a deep learning accelerator, data processing units (DPUs), and/or the like. In at least one embodiment, a GPU 110C includes multiple cores 211C, each core being capable of executing multiple threads 212C. Each core may run multiple threads 212C concurrently (e.g., in parallel). In at least one embodiment, threads 212C may have access to registers 213C. Registers 213C may be thread-specific registers with access to a register restricted to a respective thread. Additionally, shared registers 214C may be accessed by one or more (e.g., all) threads of the core. In at least one embodiment, each core 211C may include a scheduler 215C to distribute computational tasks and processes among different threads 212C of core 211C. A dispatch unit 216C may implement scheduled tasks on appropriate threads using correct private registers 213C and shared registers 214C. Computing system 100C may include input/output component(s) (I/O) 217C to facilitate exchange of information with one or more users or developers.

In at least one embodiment, GPU 110C may have a (high-speed) cache 218C, access to which may be shared by multiple cores 211C. Furthermore, computing system 100C may include a GPU memory 219C where GPU 110C may store intermediate and/or final results (outputs) of various computations performed by GPU 110C. After completion of a particular task, GPU 110C (or CPU 130C) may move the output to (main) memory 104C. In at least one embodiment, CPU 130C may execute processes that involve serial computational tasks whereas GPU 110C may execute tasks (such as multiplication of inputs of a neural node by weights and adding biases) that are amenable to parallel processing.

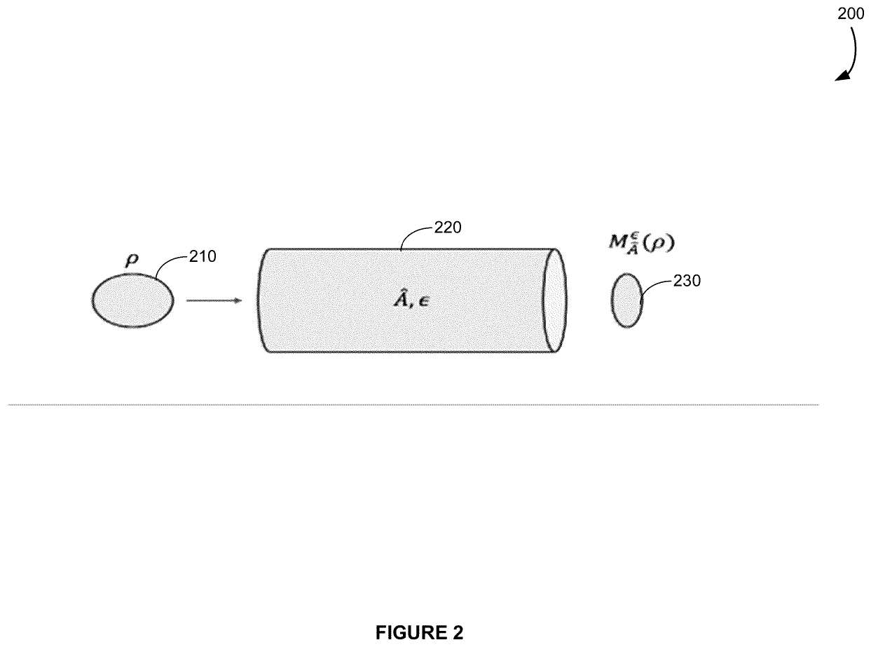

Further details regarding implementing noisy channel error mitigation, including training machine learning models to implement noisy channel error mitigation, will now be described below with reference to FIGS. 2-13B.

FIG. 2 is a diagram 200 illustrating a method of utilizing weak measurements to perform error mitigation on noisy quantum channels, according to at least one embodiment. As shown, a quantum state 210, represented by the density matrix “ρ”, enters a weak measurement channel 220 associated with a basis designated by “Â” and a measurement strength designated by “ε”. The weak measurement channel 220 can generate a measurement 230 of the quantum state 210 onto the basis of Â observable with measurement strength ε, represented by

$$M \frac{ε}{\hat{A}} ( ρ ) .$$

The following is a formal mathematical description of weak measurements that can be used as training data for training a machine learning model for noisy quantum channel error mitigation, and machine learning models (e.g., diffusion models) used to implement noisy quantum channel error mitigation. In at least one embodiment, a complex density matrix is represented as a real-valued vector by concatenating and flattening its real and imaginary components, resulting in input sequences made up of these vectors. This representation may enable the machine learning model to process quantum state data using neural network operations designed for real-valued inputs.

For an arbitrary two state quantum system |ψ [symbol] =Σᵢαᵢ|i [symbol] , a weak measurement of |ψ [symbol] can be made with respect to an observable Â. The quantum system represented by quantum state |ψ [symbol] can be weakly coupled to an auxiliary quantum system referred to as the “pointer state” or “pointer.” The pointer is typically modeled as a continuous variable quantum system, represented by the quantum state |φ [symbol] =∫ψₓ|x [symbol] dx, where ∫|ψₓ|²dx=1. The interaction between the quantum system |ψ [symbol] and the pointer |φ [symbol] can be governed by the von Neumann projection measurement scheme, which applies a unitary operator to the joint state based on |ψ [symbol] and |φ [symbol] . For example, a Von Neumann projection measurement can be performed as follows:

$${e}^{- i γ \hat{A} ⊗ \hat{P}} \vert ψ 〉 \vert ϕ ( x ) 〉 = \vert ψ 〉 \vert ϕ ( x - γ {a}_{i} ) 〉 \qquad ( 1 )$$

where γ is a small coupling parameter corresponding to an interaction strength (γ<<1) and \hat{P} is a momentum operator. This interaction causes the pointer to shift in accordance with the eigenvalues of Â and the coupling parameter γ. After the interaction, tracing out the pointer degrees of freedom defines a monitoring transformation [symbol] (φ, which can describe the evolution of the initial quantum state represented by the density matrix ρ=|ψ [symbol] [symbol] ψ| under the influence of the weak measurement as follows:

$$ℳ ( ρ ) = ( 1 - ε ) ρ + {εΦ}_{\hat{A}} ( ρ ) \qquad ( 2 )$$

where ε is a measurement strength parameter, which quantifies how strongly the measurement disturbs the system (with ε=0 corresponding to no measurement and ε=1 corresponding to a fully projective measurement). Φ_{Â}(ρ) represents a specific type of noise, error or operation that acts on p (e.g., depolarizing, dephasing, bit-flip, phase-flip, amplitude damping, etc.). The monitoring transformation described by equation (2) decomposes the initial pre-measured density matrix into two components: an original (unmeasured) quantum state component and a projected quantum state component. The projected quantum state component corresponds to the quantum state after it has been projected onto the eigenbasis of the measured observable, representing the outcome of a projective measurement. Thus, the measurement strength parameter ε determines the relative weights of each component. In at least one embodiment, sequential weak measurements are performed to generate simulated training data. More specifically, multiple weak projections can be applied in succession. Collectively, these multiple weak projections can approximate the effect of a single strong (projective) measurement, but with each step only partially collapsing the quantum state. This approach allows for the extraction of partial or approximate information about several observables simultaneously, especially when the observables do not commute. However, it is important to note that weaker measurements yield less precise information about the observable, and the results are more susceptible to statistical fluctuations. Furthermore, performing sequential weak measurements on non-commuting observables can be more disruptive to the quantum state than a single projective measurement, as each measurement can partially erase information gained from previous measurements. When sequential weak measurements are performed on the same observable with the same measurement strength parameter ∈, the cumulative effect can be described by a series of n monitoring transformations. This can lead to a gradual evolution of the quantum state ρ as described by the following equation:

$${[ M ( ρ ) ]}^{n} = {( 1 - ϵ )}^{n} ρ + ( 1 - {( 1 - ϵ )}^{n} ) {Φ}_{\hat{A}} ( ρ ) \qquad ( 3 )$$

It can be seen that the quantum state ρ can be gradually transformed into the projected component on the observable basis. Performing sequential weak measurements on many different observables Oᵢ∈{A, B, C, D . . . } yields a transformation represented by the following nested sum equation:

$${ρ}^{out} = {( 1 - ϵ )}^{n} ρ + {\sum }_{i} ( ϵ {( 1 - ϵ )}^{n - 1} {Φ ( ρ )}^{{O}_{i}} + {\sum }_{j} ( {ϵ}^{2} {( 1 - ϵ )}^{n - 2} {Φ ( ρ )}^{{O}_{i} {O}_{j}} + {\sum }_{k} ( {ϵ}^{3} {( 1 - ϵ )}^{n - 3} {Φ ( ρ )}^{{O}_{i} {O}_{j} {O}_{k}} + … + {\sum }_{z} ( {ϵ}^{n} {Φ ( ρ )}^{{O}_{i} … {O}_{z}} ) ) \text{?} \qquad ( 4 )$$

$$\text{?} \text{indicates text missing or illegible when filed}$$

Thus, the evolution of the quantum state can depend on the measurement strength parameter ∈. In certain scenarios, this dependence can lead to an equal decomposition of the density matrix ρ across all measured observables, effectively distributing the quantum information. When a sequence of weak measurements is performed, the quantum state undergoes a gradual evolution, taking incremental steps towards the maximally mixed state (i.e., a complete loss of information about the original quantum state). This process is a result of the cumulative decoherence introduced by the sequential weak measurements. However, if the quantum state is weakly projected onto a large set of non-commuting observables, the system can resist full decoherence, making it nearly impossible to reach the maximally mixed state. This is because the information about the initial quantum state is distributed among incompatible measurement bases, and no single measurement can fully erase it. In such cases, Two-State Vector Formalism (TSVF), which often relies on post-selection of the density matrix p, may not be applicable for describing the system's evolution. Instead, the quantum state can naturally approach the maximally mixed state through the dissipative effects of weak measurements, a process that can be further facilitated by coupling to auxiliary systems or environments. In some instances, machine learning techniques such as Generative Adversarial Networks (GANs) can be employed to assist in denoising quantum states by learning to distinguish and correct noise-induced errors, thereby improving the fidelity of quantum information processing in the presence of weak measurement-induced decoherence.

The following provides a more detailed description of implementing machine learning models, and specifically diffusion models in at least one embodiment, that can be utilized for error mitigation in noisy quantum channels. As described above, a diffusion model can be trained by employing a forward diffusion process, which incrementally adds noise to the original (“denoised” or “clean”) quantum state data across multiple steps, ultimately resulting in “fully-noised” quantum state data (i.e., the quantum state after the final noise-addition step). For example, the original quantum state data can be representative of a pure quantum state. The diffusion model can then learn a reverse diffusion process, which aims to reconstruct the original quantum state data from the fully-noised data by sequentially removing the noise in a stepwise manner. This approach enables the diffusion model to approximate the inverse of the noise added by the forward diffusion process, thereby facilitating the recovery of the original quantum state. The forward and reverse diffusion processes can be parameterized as Markov chains, and the diffusion model can be trained to minimize the discrepancy between the reconstructed and original quantum states, often using loss functions such as mean squared error or quantum fidelity metrics.

For example, the forward diffusion process for a data distribution q(x⁽⁰⁾) can be written as:

$$q ( {x}^{( 0 … T )} ) = q ( {x}^{( 0 )} ) {\prod }_{t = 1}^{T} q ( {x}^{( t )} \vert {x}^{( t - 1 )} ) \qquad ( 5 )$$

In equation (5), x^{(t)} represents the quantum state data after t steps of adding noise during the forward diffusion process (e.g., x⁽⁰⁾ is the original quantum state data and x^{(T)} is the fully-noised quantum state data), q(x⁽⁰⁾) represents the probability distribution of the original quantum state data, q(x^{(t)}) represents the probability distribution of the quantum state data at step t of the forward diffusion process, and q(x^{(0 . . . T)}) represents the joint probability distribution of the entire diffusion trajectory from x⁽⁰⁾ to x^{(T)} (i.e., the probability of observing this particular sequence of noisy quantum states from start to finish). The term q(x^{(t)}|x^{(t-1)}) represents the conditional probability of the quantum state data at step t given x^{(t-1)} (i.e., the probability of transitioning from one noisy quantum state to the next noisy quantum state). In at least one embodiment, q(x^{(t)}|x^{(t-1)})=T_{π}(x^{(t)}|x^{(t-1)}; βₜ), where T_{π} is the Markov kernel and βₜ is the diffusion rate controlling the amount of noise added at each step. Accordingly, equation (5) essentially states that the joint probability of the entire diffusion trajectory can be expressed as the probability of the original (denoised) quantum state data multiplied by the product of the conditional probabilities of transitioning from one noisy quantum state to the next.

The reverse diffusion process can be written as:

$$p ( {x}^{( 0 )} ) = p ( {x}^{( T )} ) {\prod }_{t = 1}^{T} p ( {x}^{( t - 1 )} \vert {x}^{( t )} ) \qquad ( 6 )$$

In equation (6), p(x^{(t)}) represents the probability distribution of quantum state data at step t of the forward diffusion process, p(x⁽⁰⁾) represents the probability distribution of the original quantum state data, and p(x^{(T)}) represents the probability distribution of the fully-noised quantum state data). The term p(x^{(t-1)}|x^{(t)}) represents the conditional probability of the data at step t−1 given x^{(t)} (i.e., the probability of denoising the quantum state data by one step). Therefore, equation (6) essentially states that states that the probability of the original quantum state data can be expressed as the probability of the fully-noised quantum state data multiplied by the product of the conditional probabilities of reversing each noise step. Accordingly, equation (6) can govern the process of training the diffusion model to implement a reverse diffusion process to generate, based on an arbitrary noisy quantum state, a prediction of an original quantum state.

A noisy quantum channel, acting on an input quantum state represented by a density matrix ρ, can be represented by [symbol] (ρ), such that ρ= [symbol] ( [symbol] (ρ)) where [symbol] (·) represents the inverse quantum channel. The inverse quantum channel is not necessarily a physical quantum channel. As an illustrative example, a noisy quantum channel can be implemented as a depolarizing channel. However, other types of noisy quantum channels are contemplated, which can have more complicated inverse quantum channels. A depolarizing channel model can be used to represent a type of noise in quantum systems where information is lost by projecting the state onto a statistical mixture of all possible states. A depolarizing channel can be modeled by

$${D}_{p} ( ρ ) = p ρ + ( 1 - p ) \frac{Tr ( ρ )}{{2}^{n}} \text{?} ,$$

where Dₚ(ρ) represents the output quantum state after it has passed through the depolarizing channel. The term

$$\frac{Tr ( ρ )}{{2}^{n}} \text{?}$$

represents the maximally mixed state within an associated Hilbert space, where Tr(ρ) is the trace of the density matrix representing the quantum state (e.g., Tr(ρ)=1 for a valid quantum state), n is the number of qubits defining the dimensionality of the Hilbert space, and [symbol] is the identity matrix within the Hilbert space (e.g.,

$$( \begin{matrix}1 & 0 \\ 0 & 1\end{matrix} )$$

in a single qubit implementation). Thus, in a single qubit implementation, the maximally mixed state for a valid quantum state can be represented by

$$\frac{1}{2} ( \begin{matrix}1 & 0 \\ 0 & 1\end{matrix} ) .$$

The parameter p represents the probability that the quantum state represented by ρ passes through the depolarizing channel undisturbed and (1−p) represents the probability the quantum state is depolarized by the depolarizing channel. For example, if p=1 then the depolarizing channel is ideal and D₁(ρ)=ρ. As another example, if p=0, then the depolarizing channel maximally depolarizes the quantum state, thereby turning the quantum state into a maximally mixed state. It can be deduced that the inverse depolarizing channel can be modeled by

$${D}_{p}^{- 1} ( ρ ) = \frac{1}{p} ρ - ( 1 - \frac{1}{p} ) \frac{T r ( ρ )}{{2}^{n}} \text{?} .$$

In at least one embodiment, a quantum channel (and similarly an inverse quantum channel) can be represented by a global channel defined as a product of local channels. For example,

$$ℳ ( ρ ) = {⊗}_{i = 1}^{N} {ℳ}_{i} ( {ρ}_{i} ) ,$$

where [symbol] ᵢ(ρᵢ) is an i-th local quantum channel corresponding to an i-th local quantum state ρᵢ, and

$$ρ = {⊗}_{i = 1}^{N} {ρ}_{i} .$$

The quantum channel can act on the quantum state T times as described above, which can be represented by:

$${ℳ}^{( 1 … T )} ( ρ ) = {Π}_{t = 1}^{T} ( {⊗}_{i = 1}^{N} {ℳ}_{i} ( {ρ}_{i}^{t} ) ) = {Π}_{t = 1}^{T} ( ℳ ( {ρ}^{t} ) ) \qquad ( 7 )$$

and the inverse quantum channel can be represented by:

$${( {ℳ}^{( 1 … T )} )}^{- 1} ( ρ ) = {Π}_{t = 1}^{T} ( {⊗}_{i = 1}^{N} {ℳ}_{i}^{- 1} ( {ρ}_{i}^{t} ) ) = {Π}_{t = 1}^{T} ( {ℳ}^{- 1} ( {ρ}^{t} ) ) \qquad ( 8 )$$

The product of small inverse quantum channels can act as an error mitigation protocol to remove the noise from a noisy quantum channel. It can also help with identifying more trivial and compact structures in quantum computer algorithms. For example, it may be possible to denoise a single qubit quantum state on a quantum circuit algorithm that acts on an arbitrary state e^{-iHt}|ψ [symbol] →UpU^{†}, where [symbol] |ψ [symbol] corresponds the time-evolved pure quantum state at time t starting from an initial pure state |ψ [symbol] and Hamiltonian [symbol] , U is an operator representing a reversible quantum operation or evolution, and U^{†} is the Hermitian conjugate of U (e.g., if U is a unitary operator, then U^{†}=U⁻¹). The Hamiltonian [symbol] for the entire system (including the pointers) can be separated into n steps using a Trotter approximation

$${e}^{- i ℋ t} \approx {( {\prod }_{k} {e}^{- i {ℋ}_{k} t / n} )}^{n} ,$$

where [symbol] =Σₖ [symbol] ₖ. Using the Trotter approximation can enable noise to be cleaned from a gate-dependent quantum algorithm, and can enable noise to be used with auxiliary quantum data (e.g., qubits) to generate a quantum algorithm.

As described above, the goal of noisy quantum channel error mitigation described herein is to determine a suitable inverse quantum channel that can transition from an approximately maximally mixed state towards a pure quantum state. As also described above, an LSTM is one type of architecture that can be used to implement a machine learning model (e.g., diffusion model) to determine the inverse quantum channel given the ability of the LSTM to effective handle time sequence data. The short-term correlations of the LSTM can be calculated from each time step t that is an iteration with unknown monitoring channel M(ρ) which transforms density matrix ρ^{(t)}→ρ^{(t+1)}. The LSTM input will be ρ^{(T)}, where ρ^{(T)} represents the fully-noised quantum state at the final time step T (up to some predetermined threshold), and the LSTM output is the approximated inverse sequence from ρ^{(T)} to ρ⁽⁰⁾, where ρ⁽⁰⁾ represents original, denoised quantum state. Thus, the LSTM can remove noise that was induced on ρ. The LSTM also has the capability to transform one density matrix into other via the following sequence:

$${ρ}_{1}^{0} , … , {ρ}_{1}^{τ} , {ρ}_{0}^{T} , … , {ρ}_{2}^{T} .$$

The LSTM can transform a pure quantum state into a mixed state (e.g., a maximally mixed state). The evolution of a first quantum state represented by a first density matrix ρ₀ under a first sequence of weak measurements simulating a noisy quantum channel can be represented as

$$( {ρ}_{0}^{( 0 )} , {ρ}_{0}^{( 1 )} , … {ρ}_{0}^{( T - 1 )} , {ρ}_{0}^{( T )} ) .$$

### Here,

$${ρ}_{0}^{( 0 )}$$

represents a first random pure quantum state and

$${ρ}_{0}^{( T )}$$

represents the maximally mixed state (e.g., interpreted as white noise).

$${ρ}_{0}^{( T )}$$

can be approximately equal to

$$\frac{\text{?}}{d} ,$$

where d is the dimension of the Hilbert space (e.g., 2 for a single qubit).

$${ρ}_{0}^{( 0 )}$$

is the initial quantum state for the noisy quantum channel, meaning that the noisy quantum channel is designed to operate in accordance with this transformation. The set of weak measurements may be unknown, but they act as a noisy quantum channel, and in average if ∈<<1, then the average noisy quantum channel can act as a depolarized quantum channel. In the limit where ∈ approaches zero, the model simulates an average behavior describing a non-causality quantum process. After the evolution of the first quantum state

$${ρ}_{0}^{( 0 )} ,$$

the noisy quantum channel's input state can be changed to a second random pure quantum state

$${ρ}_{1}^{( 0 )} .$$

For example,

$${ρ}_{1}^{( 0 )}$$

can be a rotation of

$${ρ}_{0}^{( 0 )} ( e . g . , {ρ}_{1}^{( 0 )} = {e}^{- i ℋ t} {ρ}_{0}^{( 0 )} {e}^{i ℋ t} ) .$$

Thus, the evolution of the second quantum state represented by the second density matrix ρ₁ under a second sequence of weak measurements simulating the noisy quantum channel can be represented as

$$( {ρ}_{1}^{( 0 )} , {ρ}_{1}^{( 1 )} , … {ρ}_{1}^{( T - 1 )} , {ρ}_{1}^{( T )} ) .$$

A training dataset D used to train the machine learning model can include n examples. For example,

$$D = \{ {ρ}_{i}^{( j )} \vert i ∈ \{ 0 , … n \} , j ∈ \{ 0 , … T \} \} .$$

In at least one embodiment, the input features of the machine learning model are defined as follows: [N, S, 2, D, 2, 2], where Nis number of examples (batch size), S is the sequence length, 2 defines real and imaginary, D is the number of qubits, and 2, 2 defines a 2×2 size of the density matrix representing the quantum state. The data loader class convert the input features into converted features [N, S, 8D], and then pass the converted features through the machine learning model. For each sequence, the machine learning model can predict an output corresponding to the original quantum state and/or the inverse quantum channel that transforms the final fully-noised quantum state back to the original quantum state. The output can be determined via the machine learning model weights.

Assume a simple single qubit case, where D=1. The state space of a single qubit can be geometrically represented by a Bloch sphere, which is a unit sphere. In particular, each pure state of the qubit can be mapped to a point on the surface of the Bloch sphere, while each mixed state of the qubit can be represented by any point inside Block sphere (i.e., not on the surface). For a single qubit, a density matrix representing the state of the qubit can be written as

$$ρ = \frac{1}{2} ( I + \vec{r} \cdot \vec{σ} ) = \frac{1}{2} ( I + {r}_{x} {σ}_{x} + {r}_{y} {σ}_{y} + {r}_{z} {σ}_{z} ) ,$$

where \vec{r} is a the Bloch vector (i.e., ∥\vec{r}∥₂=1 for a pure state and ∥\vec{r}∥₂<1 for a mixed state) and \vec{σ} represent Pauli matrices. Pauli matrices are Hermitian and unitary matrices that represent operators that can be used to describe spin-½ particles such as qubits. In particular, each Pauli matrix corresponds to a rotation around the respective axis on the Bloch sphere. For example,

$${σ}_{x} = ( \begin{matrix}0 & 1 \\ 1 & 0\end{matrix} ) , {σ}_{y} = ( \begin{matrix}0 & - i \\ i & 0\end{matrix} ) and {σ}_{z} = ( \begin{matrix}1 & 0 \\ 0 & - 1\end{matrix} ) .$$

Any change or displacement to the quantum state of the qubit (e.g., due to a weak interaction, a small rotation, or a short period of evolution under a Hamiltonian) can be described as a change or displacement of the Bloch vector \vec{r} by Δ\vec{r}·\vec{σ}=Δrₓσₓ+Δr_{y}σ_{y}+Δr_{z}σ_{z}, which can start from a quantum state close to the maximally mixed state (∥\vec{r}|₂→0).

The effect of a noisy quantum channel on the Bloch radius can be described by the affine transformation \vec{r}^{(t+1)}=\hat{M}·\vec{r}^{(t)}+\vec{t}, where \vec{r}^{(t)} is the Bloch radius at a time step t, \vec{r}^{(t+1)} is the Bloch radius at time step t+1 after noise is added, \hat{M} is a linear transformation matrix representing linear transformation(s) of the affine transformation (e.g., scaling, rotation and/or shearing of \vec{r}^{(t)}), and \vec{t} is a translation vector representing a translational transformation of the affine transformation. The inverse quantum channel that reverses the noise introduced by the quantum channel to recover the original quantum state of the qubit can therefore be represented as: \vec{r}^{(t)}=\hat{M}⁻¹·(\vec{r}^{(t+1)}−\vec{t}), where \hat{M}⁻¹ is the inverse linear transformation matrix. Because the quantum channel weakly disturbs the quantum state, the affine transformation representing the quantum channel can also be written to take into account any prior knowledge of the measurement strength parameter ε as follows: \vec{r}^{(t+1)}=(1−ε)\vec{r}^{(t)}+ε(\hat{M}·\vec{r}^{(t)}+\vec{t}).

\hat{M} and \vec{t} can be defined in accordance with the type of noisy quantum channel being represented. In the illustrative depolarizing channel example described above, which can map pure states toward the maximally mixed state, \hat{M} can be defined as a scaled identity matrix that shrinks the Bloch sphere and \vec{t} can be the zero vector.

The following will now describe further details of the forward diffusion process. As mentioned above, a quantum channel can be represented by equation (7) as follows:

$${ℳ}^{( 1 … T )} ( ρ ) = {\prod }_{t = 1}^{T} ( {⊗}_{i = 1}^{N} {ℳ}_{i} ( {ρ}_{i}^{t} ) ) = {\prod }_{t = 1}^{T} ( ℳ ( {ρ}^{t} ) ) .$$

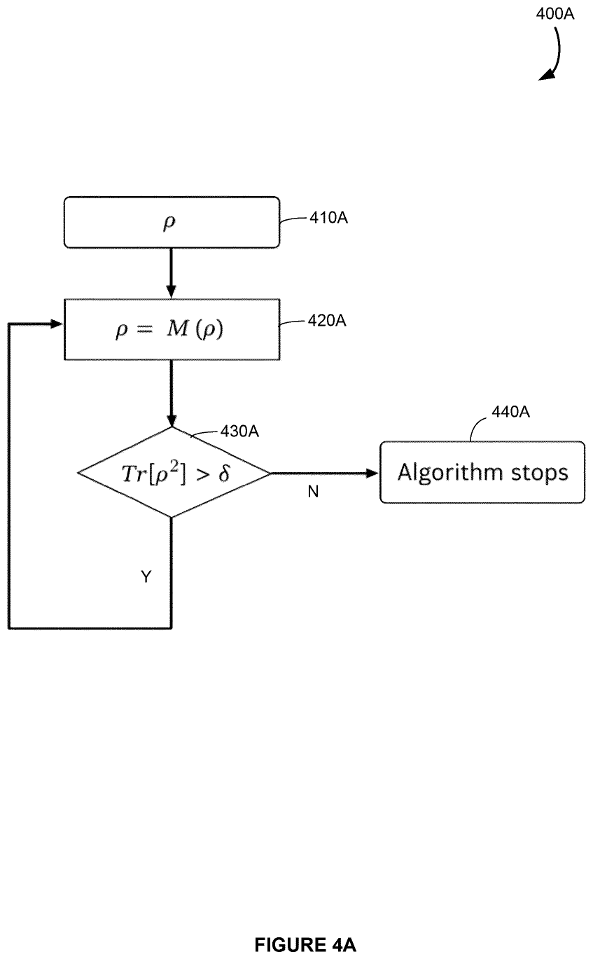

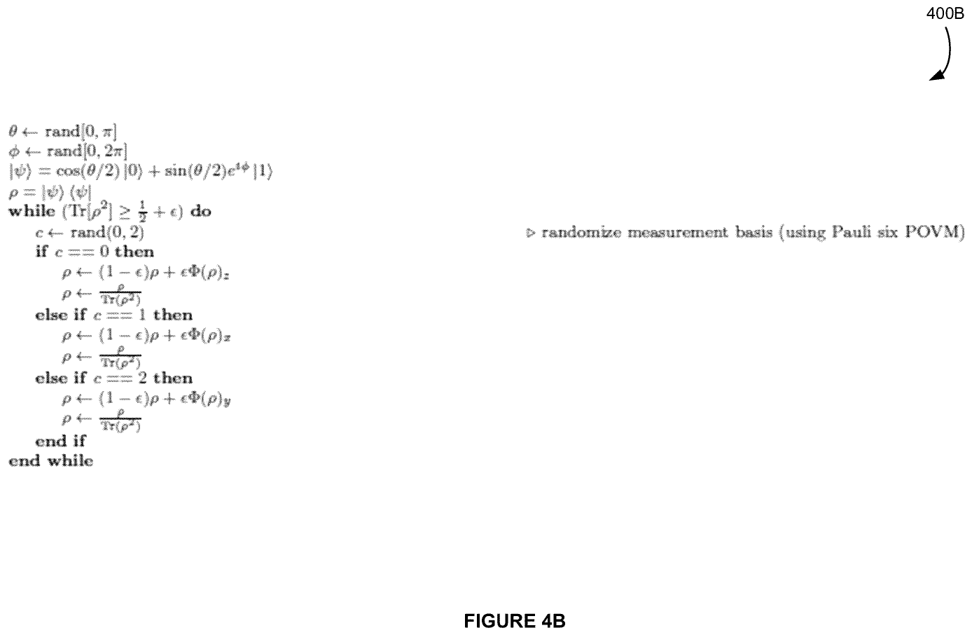

The forward diffusion process can be further performed based on a finite set of POVM elements, where the trivial case is the Paul six POVM. The quantum channel being simulated by the weak measurements can be randomized using a forward diffusion process algorithm, where the measurement strength can be the same for each randomized measurement. A first quantum state can be weakly measured until it is mapped to a fully-noised quantum state (e.g., transformed into the maximally mixed state or a near-maximally mixed state). At this point, the quantum channel is well-defined and can be applied to other examples. Further details regarding implementing the forward diffusion process will be described below with reference to FIGS. 4A-4B.

FIG. 3 is a diagram of machine learning model architecture (“architecture”) 300, in accordance with at least one embodiment. The architecture 300 can be used to implement a machine learning model (e.g., quantum diffusion model process) that can perform noisy quantum channel error mitigation. More specifically, the architecture 300 represents an LSTM.

As shown in FIG. 3, the LSTM receives input data at a current time step t. In at least one embodiment, the input data includes three input data items (e.g., vectors). The three input data items include the cell state generated by the LSTM during the previous time step t−1 (“Cₜ₋₁”) 302, the hidden state at the previous time step t−1 (“Hₜ₋₁”) 304 and an external data item provided to the LSTM at the current time step t (“Xₜ”) 306. Cₜ₋₁ 302 serves as the long-term memory of the network by preserving information across many time step, while Hₜ₋₁ 304 captures short-term dependencies by capturing information relevant to the current time step. Xₜ 306 can represent new data or features relevant to the current time step t, such as measurement outcomes or encoded quantum information.

The LSTM can use the input data to generate the cell state during the current time step t (“Cₜ”) 308 and the hidden state during the current time step t (“Hₜ”) 310. Hₜ 310 can be used for downstream tasks or passed to subsequent layers. The performance of the LSTM can be evaluated based on this output, as it reflects the ability of the LSTM to capture and utilize relevant temporal data dependencies.

To generate Cₜ 308 and Hₜ 310, the architecture 300 can further include a set of gates. The set of gates can enable the LSTM to learn temporal patterns and dependencies in sequential data by combining the recent past information represented by Hₜ₋₁ 304 with the new data or features represented by Xₜ 306, thereby updating the long-term memory represented by Cₜ₋₁ 302. Specifically, the set of gates determines how information is retained, updated, or discarded, transforming the values of Cₜ₋₁ 302 and Hₜ₋₁ 304 into Cₜ 308 and Hₜ 310. Architecturally, each gate of the set of gates can be implemented as a dedicated neural network layer that includes an activation function to regulate the flow of information. In at least one embodiment, the activation function of at least one gate is the sigmoid function, which outputs values between 0 and 1 to control the degree of information passage. The gates are used to generate the updated cell and hidden states by selectively filtering and combining the relevant information from previous states and current inputs. For example, as shown in FIG. 3, the set of gates can include a forget gate (Fₜ) 312, an input gate (Iₜ) 314, and an output gate (Oₜ) 316. Each of the gates 312-316 can be provided with a same gate input formed by combining Hₜ₋₁ 304 and Xₜ 306 (e.g., concatenated together in a gate input vector).

The forget gate 312 evaluates the gate input to determine which portions of the previous cell state Cₜ₋₁ 302 should be retained or discarded, and subsequently generates an updated cell state 313 derived from Cₜ₋₁ 302. Specifically, the forget gate 312 produces a forget gate selector data item, typically as a selector vector with values ranging between 0 and 1. Each element of this selector vector can correspond to a respective element in Cₜ₋₁ 302 and acts as a multiplicative mask. For example, a value closer to 1 allows the corresponding information to be retained, while a value closer to 0 causes that information to be discarded. The updated cell state 313 is computed by performing element-wise multiplication between the forget gate selector vector and Ct₋₁ 302. This enables the LSTM to selectively preserve or remove information from Cₜ₋₁ 302, which can facilitate long-term memory retention or forgetting (as necessary).

The input gate 314 determines the extent to which new information from Xₜ 306 should be incorporated into Cₜ 308. To facilitate this, the architecture 300 may include a candidate memory component (CM) 318, which can be implemented as a separate neural network layer. CM 318 can generate a candidate memory data item, typically represented as a candidate memory vector. In at least one embodiment, the output neurons of CM 318 apply a candidate memory value function to ensure that all elements of the candidate memory vector are constrained within a given range. For example, the given range can be from −1 to 1. One example of a candidate memory value function that can be used to ensure that all elements of the candidate memory vector are constrained within the range of −1 to 1 is the hyperbolic tangent function (tanh).

The input gate 314 produces an input gate selector data item, often in the form of a selector vector with values between 0 and 1. This selector vector is used to modulate the candidate memory vector through element-wise multiplication, resulting in a cell state modification data item (“data item”) 319. This operation allows the network to control the degree to which each element of the candidate memory vector influences the cell state update.

The resulting data item 319 can then be combined with the updated cell state 313 at a combiner 320 to produce the new cell state Cₜ 308. In at least one embodiment, the combiner 320 performs an element-wise addition of the data item 319 and the updated cell state 313 to generate Cₜ 308. This process enables the LSTM to selectively integrate new information while retaining relevant aspects of Cₜ₋₁ 302, which can support both learning of new patterns and preservation of long-term dependencies.

The output gate 316 can determine the value of Hₜ 310, which is an output that can be used as input at the next time step t+1. To accomplish this, the output gate 316 can generate an output gate selector data item (e.g., selector vector) based on Hₜ 304 and Xₜ 306. The architecture 300 can include a cell state normalizer 322, which applies a nonlinear activation function to the cell state Cₜ 308 produced by the combiner 320. This normalization ensures that the values of Ct 308 are constrained within a range, typically between −1 and 1 (e.g., using tanh), which helps stabilize training and prevents the cell state from growing unbounded. The output gate selector data item and the normalized cell state are then combined using a combiner 324, which typically performs element-wise multiplication, to generate Hₜ 310. This mechanism allows the LSTM to control how much of the cell state's information is exposed at each time step, enabling selective output of relevant information.

The LSTM represented by architecture 300 can be trained using any suitable technique. In at least one embodiment, the LSTM is trained using backpropagation, specifically backpropagation through time (BPTT). In BPTT, gradients are propagated backward through the sequence of time steps, allowing the model to learn temporal dependencies. The effectiveness of BPTT can depend on the cell state, as the gradients with respect to the cell state at each time step influence how information is retained or forgotten. The gradient calculation for backpropagation through time can be determined, at least in part, by the ratio of change between Cₜ 308 and Cₜ₋₁ 302 (e.g., ∂C/∂Cₜ₋₁), where this ratio reflects the combined effects of the forget, input, and output gates 312-316, as well as CM 318. By adjusting these components during training, the LSTM can learn to control the flow of information and manage long-term dependencies to optimize performance for the task of recovering original quantum state data from noisy quantum state data.

The following sets forth an exemplary, non-limiting procedure for training the LSTM of FIG. 3 to approximate the inverse of an arbitrary, non-unitary quantum channel and thereby map noisy quantum state data back to corresponding noise-free (original) quantum state data. Unless otherwise indicated, all variables, notation, and reference numerals correspond to those already introduced elsewhere in the present specification.

In at least one embodiment, a supervised learning task is used to train the LSTM. The supervised learning task is formalized as training the LSTM to learn the function F_{θ}:ρ^{T}→ρ⁰ where ρ^{T} denotes the density matrix represented a fully-noised quantum state after T interactions with a non-unitary (noisy) quantum channel M, ρ⁰ is the density matrix representing the LSTM's prediction of the original quantum state (e.g., pure quantum state), and θ is a parameter including all trainable weights and biases of the LSTM.

To train the LSTM, a random pure quantum state can be initialized. More specifically, initializing the random pure quantum state can include initializing a polar angle parameter θ to a randomly selected value between 0 and π, inclusive, initializing an azimuthal angle parameter φ to a randomly selected value between 0 and 2π, inclusive, and initializing an original (e.g., pure) quantum state vector representing the original (e.g., pure) quantum state |ψ [symbol] as

$$cos ( \frac{θ}{2} ) \vert 0 〉 + sin ( \frac{θ}{2} ) {e}^{i ϕ} \vert 1 〉 .$$

Then, a forward diffusion process can be performed to add noise to the original quantum state. The output of the forward diffusion process can be recorded as a training example. For example, FIG. 4B is a forward diffusion process algorithm (“algorithm”) 400, in accordance with at least one embodiment. As shown in FIG. 4B, a random pure quantum state is initialized. More specifically, as described above with reference to FIG. 3, initializing the random pure quantum state includes initializing a polar angle parameter θ to a randomly selected value between 0 and π, inclusive, initializing an azimuthal angle parameter φ to a randomly selected value between 0 and 2π, inclusive, initializing the pure quantum state vector |ψ [symbol] as

$$cos ( \frac{θ}{2} ) \vert 0 〉 + sin ( \frac{θ}{2} ) {e}^{i ϕ} \vert 1 〉 ,$$

and initializing the density matrix ρ as |ψ [symbol] [symbol] ψ|.

After initializing the set of parameters, a while loop is initiated. The while loop continues to be performed as long as a threshold quantum state purity condition is satisfied. In this example, quantum state purity is defined by the trace of ρ², Tr(ρ²). For a pure state, Tr(ρ²)=1 and for a maximally mixed state,

$$Tr ( {ρ}^{2} ) = \frac{1}{d}$$

where d is the dimension of the associated Hilbert space. In the example of a single qubit (as shown in FIG. 4B), the associated Hilbert space has two dimensions (d=2), and Tr(ρ²) for the single qubit in the maximally mixed state is

$$\frac{1}{2} .$$

The while loop continues to operate as long as Tr(ρ²) is greater than or equal to

$$\frac{1}{2} + ϵ .$$

That is, the quantum state in this example represents a qubit. However,

$$\frac{1}{2} + ϵ$$

may be generalized to

$$\frac{1}{d} + ϵ$$

in other embodiments in which the quantum state does not correspond to a single qubit.

During the while loop, a random basis measurement is applied to the density matrix, which changes the density matrix. For example, the Pauli six POVM set can be used as a measure. However, any suitable POVM set can be used. For example, a value c can be randomly selected as 0, 1 or 2. Without loss of generality, c==0 corresponds to the application of a z-basis measurement, c==1 corresponds to the application of an x-basis measurement, and c==2 corresponds to the application of a y-basis measurement as shown in FIG. 4B (similar to equation (2) described above). After applying the randomly selected basis measurement, ρ is updated to

$$\frac{ρ}{T r ( {ρ}^{2} )} .$$

If Tr(ρ²) is still greater than or equal to

$$\frac{1}{2} + ϵ ,$$

then another random basis measurement is applied. Otherwise, the process ends. Thus, the number of iterations of the while loop can correspond to the number of weak measurements that can take the original quantum state to the maximally mixed state or the near-maximally mixed state, which is controlled by the magnitude of ∈. After each measurement, the updated density matrix of the quantum state can be stored and normalized as follows:

$${ρ}^{( t + 1 )} = \frac{{ℳ}^{{O}_{t}} ( {ρ}^{( t )} )}{Tr ( {ℳ}^{{O}_{t}} ( {ρ}^{( t )} ) {( {ℳ}^{{O}_{t}} ( {ρ}^{( t )} ) )}^{†} )} \qquad ( 9 )$$

where Oₜ is the observable measured in the t-th iteration of the while loop.

Referring back to FIG. 3, a real-valued tensor encoding process can be performed. In at least one embodiment, for product states, the input features of the machine learning model are defined as follows: [N, S, 2, D, 2, 2], where Nis number of examples (batch size), Sis the sequence length, 2 defines real and imaginary, D is the number of qubits, and 2, 2 defines a 2×2 size of the density matrix representing the quantum state. The data loader class can convert the input features into converted features [N, S, 8D]. In at least one embodiment, for non-separable states, the input features of the machine learning model are defined as follows: [N, S, 2, 2^{D}, 2^{D}], and the input features can be converted into [N, S, 2^{2D+1}]. Further details regarding separable and non-separable states will be described below.

Any suitable parameters θ can be initialized in accordance with embodiments described herein. For example, forget gate biases can be set to 1 to encourage initial memory retention. As another example, the batch size N can be selected to utilize parallel processing without memory overflow (e.g., N=64).

A loss function used during the training procedure can be defined. The loss function can be used to calculate a distance metric. In at least one embodiment, the loss function includes MSE loss term L_{MSE}, which has similar properties to a Euclidean norm described above. The loss function can include additional loss terms. In at least one embodiment, the loss function further includes a fidelity loss term L_{FID} corresponding to a measure of similarity between the true and predicted density matrices. For example, the fidelity can correspond to Uhlmann fidelity. Accordingly, in at least one embodiment, the loss function is defined as L_{MSE}+L_{FID}.

The input quantum state data of the machine learning model can be represented by the density matrix

$${ρ}_{i}^{( t )} = ( \begin{matrix}{α}_{1} + i {α}_{2} & {β}_{1} + i {β}_{2} \\ {γ}_{1} + i {γ}_{2} & {δ}_{1} + i {δ}_{2}\end{matrix} )$$

having trace 1. If the machine learning model is trained on multiple qubits, then the input quantum state data of the machine learning model can become

$${\tilde{ρ}}_{i}^{( t )} = {⊗}_{k = 1}^{d} {ρ}_{i}^{( t , k )} ,$$

where

$${ρ}_{i}^{( t , k )} = ( \begin{matrix}{α}_{1 , k} + i {α}_{2 , k} & {β}_{1 , k} + i {β}_{2 , k} \\ {γ}_{1 , k} + i {γ}_{2 , k} & {δ}_{1 , k} + i {δ}_{2 , k}\end{matrix} ) .$$

Since the machine learning model can operate in the real algebraic field [symbol] rather than the complex field [symbol] , the input quantum state data should be represented by real numbers. For example, the values of the diagonal of the density matrix

$${ρ}_{i}^{( t )}$$

can be real, and the density matrix

$${ρ}_{i}^{( t )}$$

can be a Hermitian matrix. Consequently, for a two-state quantum system, the input quantum state data can be represented by a 1×8 dimension vector for each iteration in a sequence of the form

$${u}_{i}^{( t )} = [ {α}_{1} , {β}_{1} , {γ}_{1} , {δ}_{1} , {α}_{2} , {β}_{2} , {γ}_{2} , {δ}_{2} ] ,$$

and the output of the machine learning model can be the next approximate state. One or more of the features of the vector can have a zero value. This effectively creates a pure quantum state from a mixed quantum state through amplifications and predetermined rotations, which are the parameters of the inverse quantum channel and effectively act as a purification protocol.

Regarding the training procedure, the LSTM can be trained using any suitable number of input examples of quantum states that go through the randomized non-unitary quantum channel created via the addition of noise to the initial quantum state.

In at least one embodiment, the training procedure includes performing a batch assembly process by randomly sampling N samples from the training set. Input training data (e.g., input tensors) including reverse-time-ordered sequences can be constructed so that t₀ corresponds to ρ^{T} and T corresponds to ρ⁰. The input training data can be fed through the LSTM to determine, for each sample i∈N of the input training data, ρ⁰ for sample i. Then, the loss can be computed using the loss function described above. After computing the loss, BPTT can be performed to update θ. When updating θ, the parameters should maintain the evolution of the quantum state within an acceptable quantum mechanical regime. Hyper-parameters governing the simulation of the noisy quantum channel may be varied across training samples to enhance robustness to unseen noise levels. The architecture 300 may be augmented with additional components, such as attention mechanisms, bidirectional LSTM layers, etc., provided causality constraints remain satisfied. Regularization, such as via weight decay and/or early stopping, can be used to prevent over-fitting.

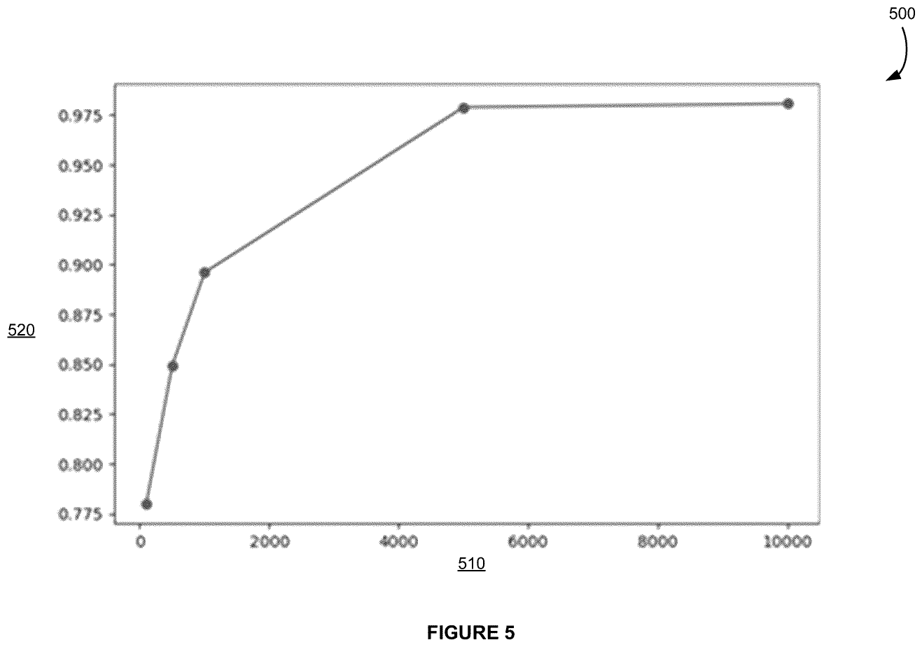

To monitor the training procedure, average fidelity can be computed on a validation set after each training epoch. For example, FIG. 5 is a graph 500 illustrating the average fidelity as a function of the number of training examples, according to at least one embodiment. In particular, the graph 500 includes an x-axis 510 corresponding to the number of training examples ranging from 100 to 10,000, and a y-axis 520 corresponding to the average fidelity. The machine learning model used included an LSTM having 250 hidden layers and 3 main layers, and the sequence length of the examples was 17 steps. In this illustrative example, ∈=0.3 and the lower bound purity is T r(ρ²)=0.7. As can be seen by the graph 500, the average fidelity of the machine learning model hit a plateau at around 0.975. This is due at least in part to the small number of parameters that the machine learning model can have compared to the small changes that occur during each iteration. Accordingly, different models may achieve better performance (e.g., an average fidelity of at least about 0.999).

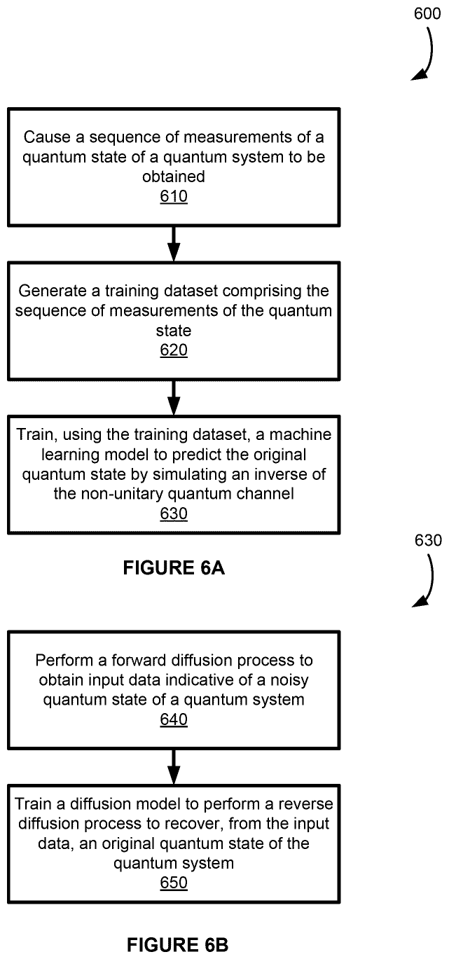

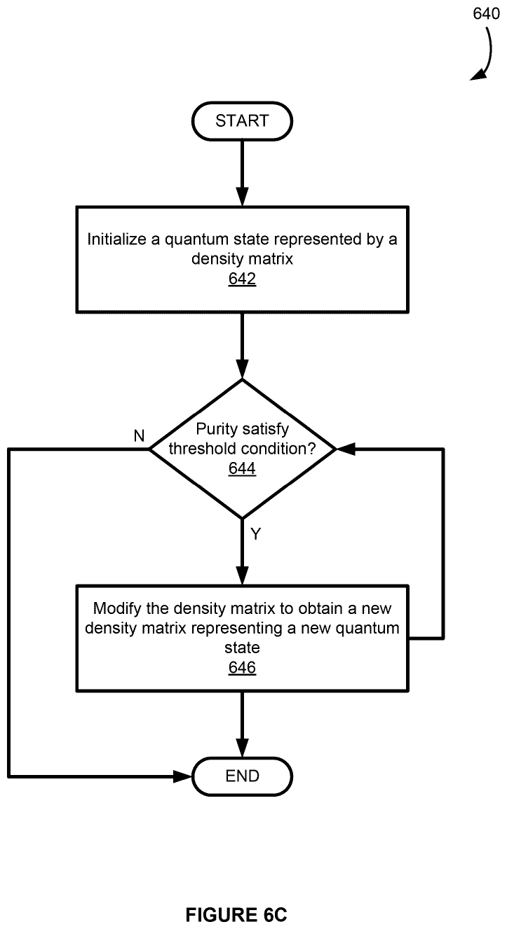

FIG. 6A is a flowchart illustrating a method 600 for training a machine learning model to implement noisy quantum channel error mitigation, in accordance with at least one embodiment. The method 600 can be performed by processing logic that may comprise hardware (e.g., circuitry, dedicated logic, programmable logic, microcode, etc.), software (e.g., instructions run on a processing device to perform hardware simulation), or a combination thereof. In at least one embodiment, the method 600 is performed by the training component 122B of the computing device 110B described above with reference to FIG. 1B.

At operation 610, processing logic causes a sequence of measurements of a quantum state of a quantum system to be obtained. In at least one embodiment, the sequence of measurements of the quantum state is a sequence of weak measurements of the quantum state that does not fully collapse a wave function corresponding to the quantum state. In at least one embodiment, the sequence of measurements of the quantum state includes multiple measurements of the quantum state captured in a temporal order. In at least one embodiment, each measurement of the sequence of measurements simulates a respective amount of noise added to an original quantum state by a non-unitary quantum channel at a respective time step. In at least one embodiment, the weak measurements are performed using a quantum measurement device, such as the quantum measurement device 130 described above with reference to FIG. 1. In at least one embodiment, the weak measurements are performed by weakly coupling the quantum system to an auxiliary quantum system referred to as a pointer state, as described above with reference to FIG. 2 and equation (1). In at least one embodiment, the interaction between the quantum system and the pointer is governed by the von Neumann projection measurement scheme, which applies a unitary operator to the joint state based on the quantum state and the pointer state. In at least one embodiment, the measurement strength parameter ε determines the degree to which the measurement disturbs the quantum system, with ε=0 corresponding to no measurement and ε=1 corresponding to a fully projective measurement. In at least one embodiment, the sequence of measurements includes measurements performed on different observables, such as measurements in the x-basis, y-basis, and z-basis. In at least one embodiment, the sequence of measurements is used to simulate the effects of various types of noisy quantum channels, including depolarizing channels, amplitude damping channels, phase damping channels, and bit-flip channels.

At operation 620, processing logic generates a training dataset including the sequence of measurements of the quantum state. In at least one embodiment, the training dataset includes multiple sequences of measurements corresponding to multiple different initial quantum states. In at least one embodiment, the training dataset includes pairs of data, where each pair includes a noisy quantum state (or a sequence of noisy quantum states) and a corresponding original pure quantum state. In at least one embodiment, generating the training dataset includes generating multiple random pure quantum states by applying random unitary matrices to a fixed reference state, such as the ground state. In at least one embodiment, each generated pure state is transmitted through a randomly selected quantum channel, which may be characterized by a specific type of quantum channel such as a depolarizing, amplitude damping, or phase damping channel. In at least one embodiment, the output noisy quantum state after transmission is recorded along with the corresponding original pure state to form a training example. In at least one embodiment, the training dataset includes density matrix representations of the quantum states at each time step of the forward diffusion process. In at least one embodiment, the training dataset is generated using both simulated data and experimental data obtained from actual quantum hardware, allowing the machine learning model to learn from real-world noise characteristics and operational imperfections.

At operation 630, processing logic trains, using the training dataset, a machine learning model to predict the original quantum state by simulating an inverse of the non-unitary quantum channel. More specifically, the machine learning model is trained to predict the original quantum state in order to perform error mitigation. In at least one embodiment, the original state is a pure quantum state. In at least one embodiment, the machine learning model is trained to map noisy quantum state information to its corresponding ideal (noise-free) quantum state. In at least one embodiment, training the machine learning model includes minimizing a cost function that measures the discrepancy between the predicted quantum state and the original quantum state. In at least one embodiment, the cost function includes a MSE term that measures the difference between the predicted density matrix and the target density matrix. In at least one embodiment, the cost function includes a trace normalization constraint that enforces Tr(p)=1, which forces the output density matrix to be normalized. In at least one embodiment, the cost function includes a penalty for non-Hermitian density matrices, taking into account the physicality of the generated quantum systems. In at least one embodiment, model performance is assessed using a geometrical fidelity metric that measures the overlap between predicted and target density matrices. In at least one embodiment, post-processing is applied to map predicted outputs back to Hermitian forms, in accordance with the constraints of a CPTP map.

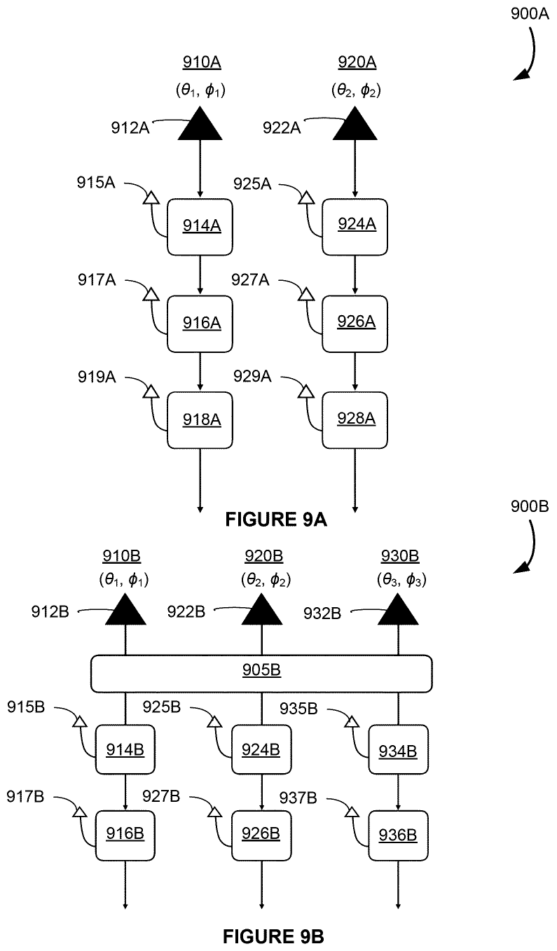

In at least one embodiment, the machine learning model is a diffusion model. In at least one embodiment, the machine learning model includes a recurrent neural network. In at least one embodiment, the recurrent neural network includes a LSTM, as described above with reference to FIG. 3. In at least one embodiment, the machine learning model is implemented using an encoder-decoder architecture with multi-head attention mechanisms (e.g., vision transformer architecture that employs self-attention mechanisms to directly model relationships between any pair of elements in the input), as described above with reference to FIG. 16. In at least one embodiment, the machine learning model is implemented using a U-Net architecture, where the encoder comprises residual blocks operating at progressively reduced spatial resolutions, with channel dimensions expanding at each stage. In at least one embodiment, quantum states and quantum operations are represented using tensor networks, as described above with reference to FIGS. 9A-9B.

In at least one embodiment, LSTM models may achieve high fidelity for separable quantum registers with many qubits (e.g., more than 10 qubits) where the noise acts like a local filter with low complexity. However, for entangled quantum registers, LSTM models may become slow and fidelity may decline as the number of qubits increases (e.g., above 6 qubits). Attention-based models may handle entangled quantum registers more efficiently and faster than LSTM models. In at least one embodiment, for entangled quantum registers, each density matrix requires proportionally 8″ features (where n is the number of qubits), while for local density matrix training, each density matrix requires proportionally 8n features. In both cases, the model is used to reconstruct the initial density matrix.

In at least one embodiment, when training on local density matrices for entangled registers, the model may tend toward overfitting, which may require implementation of regularization methods. This overfitting behavior may arise from the lack of parameters when the model is scaling up, as the larger the global state, the larger the representational decoherence.

In at least one embodiment, training the machine learning model to predict the original quantum state by simulating the inverse of the non-unitary quantum channel includes performing a reverse diffusion process to predict a backward evolution of noise added to the original quantum state in accordance with a forward diffusion process.

In at least one embodiment, training the machine learning model includes using a teacher forcing strategy that transitions gradually to autoregressive generation. In at least one embodiment, in the early stages of training, the model receives the ground-truth target from the previous time step as input at each point in the sequence, which accelerates convergence by exposing the model to ideal local inputs. In at least one embodiment, a linear-plateau schedule is used to anneal the teacher forcing probability, such that over the course of training, the model increasingly relies on its own outputs from previous steps, adapting to the eventual inference-time scenario. In at least one embodiment, the trained machine learning model can be used for state preparation in addition to error mitigation, generating target quantum states from noise by providing an appropriate input and allowing the model to produce the target output state through the learned inverse dynamics.

Further details regarding operations 610-630 are described above with reference to FIGS. 1-5 and will now be described below with reference to FIGS. 6B-6C.

FIG. 6B is a flowchart illustrating an example method for performing the operation 630 of FIG. 6A to train a machine learning model, in accordance with at least one embodiment.

At operation 640, processing logic performs a forward diffusion process to obtain input data indicative of a noisy quantum state of a quantum state. More specifically, the noisy quantum state is a pure quantum state modified by an amount of noise. In at least one embodiment, the noisy quantum state is a fully-noised quantum state. In at least one embodiment, the noisy quantum state is a maximally mixed quantum state. In at least one embodiment, the forward diffusion process incrementally adds noise to the original quantum state data across multiple steps, ultimately resulting in fully-noised quantum state data. In at least one embodiment, the forward diffusion process is parameterized as a Markov chain, where the probability distribution of the data at each step depends only on the immediately preceding step. In at least one embodiment, the forward diffusion process for a data distribution is described in accordance with equation (5). In at least one embodiment, the forward diffusion process is implemented using the algorithm described above with reference to FIGS. 4A and 4B, where a density matrix representing a quantum state is iteratively modified by applying monitoring transformations until a purity threshold condition is satisfied.

In at least one embodiment, the forward diffusion process includes one or more iterations. In at least one embodiment, training the machine learning model to predict the original quantum state by simulating the inverse of the non-unitary quantum channel includes performing each iteration of the one or more iterations of the forward diffusion process by initializing a first quantum state represented by a first density matrix associated with a Hilbert space, determining, based on the density matrix, whether a purity of the first quantum state satisfies a threshold condition defined based on a maximally mixed quantum state for the Hilbert space, and in response to determining that the purity of the first quantum state satisfies the threshold condition, modifying the first density matrix to obtain a second density matrix representing a second quantum state. In at least one embodiment, determining whether the purity of the first quantum state satisfies the threshold condition comprises determining whether a purity determined from a trace performed using the first density matrix is greater than or equal to a threshold value (e.g., in an extreme case the threshold value can be defined based on a purity determined from a trace performed using a density matrix representing the maximally mixed quantum state). In at least one embodiment, the threshold condition is evaluated by checking whether Tr[ρ²] is greater than a threshold value δ, as described above with reference to FIG. 4A. In at least one embodiment, modifying the first density matrix to obtain the second density matrix includes applying a randomly selected weak measurement to the first density matrix. In at least one embodiment, the randomly selected weak measurement is selected from measurements in the x-basis, y-basis, or z-basis, as described above with reference to FIG. 4B. In at least one embodiment, a monitoring transformation is applied to a density matrix, as described above. An example implementation of the forward diffusion process is described above with reference to FIG. 4B and will be described below with reference to FIG. 6C.

At operation 650, processing logic trains a diffusion model to perform a reverse diffusion process to recover, from the input data, an original quantum state of the quantum system. In at least one embodiment, the reverse diffusion process is learned by the diffusion model during training, where the model is trained to reverse the effects of the forward diffusion process, step by step, by predicting and removing the noise that was added at each step. In at least one embodiment, the reverse diffusion process can be written in accordance with equation (6). In at least one embodiment, the objective of the reverse diffusion process is for the model to reconstruct noise-free data from the noisy input. In at least one embodiment, the diffusion model is trained to minimize the discrepancy between the reconstructed and original quantum states using loss functions such as MSE or quantum fidelity metrics. In at least one embodiment, the trained diffusion model can approximate the inverse of a depolarizing channel, as described above. In at least one embodiment, the trained diffusion model can approximate the inverse of other types of noisy quantum channels, including amplitude damping channels and phase damping channels. Further details regarding operations 640-650 are described above with reference to FIGS. 1-6A and will now be described below with reference to FIG. 6C.

FIG. 6C is a flowchart illustrating an example method for performing the operation 640 of FIG. 6B to perform a forward diffusion process, in accordance with at least one embodiment.

At operation 642, processing logic initializes a quantum state represented by a density matrix associated with a Hilbert space. In at least one embodiment initializing the quantum state includes initializing a set of parameters. In at least one embodiment, initializing the quantum state includes initializing a set of angles for defining a Bloch sphere representation of the quantum state. In at least one embodiment, the set of angles includes a polar angle, and an azimuthal angle. In at least one embodiment, initializing the set of angles includes randomly selecting a value of the polar angle from the interval [0, π]. In at least one embodiment, initializing the set of angles includes randomly selecting a value of the azimuthal angle from the interval [0, 2π]. In at least one embodiment, initializing the set of parameters includes initializing (e.g., constructing) the quantum state based on the set of angles. In at least one embodiment, initializing the set of parameters includes initializing the density matrix ρ based on the quantum state, such as by computing ρ=|ψ [symbol] [symbol] ψ|. In at least one embodiment, the initialized quantum state is a pure quantum state with purity Tr[ρ²]=1. In at least one embodiment, for multi-qubit systems, the quantum state is initialized as a separable state, where each qubit is independently parameterized, as described below with reference to FIG. 9A. In at least one embodiment, for multi-qubit systems, the quantum state is initialized as a non-separable (entangled) state (e.g., by applying controlled-NOT operations between pairs of qubits), as described above with reference to FIG. 9B.

At operation 644, processing logic determines whether a purity of the quantum state satisfies a threshold condition defined based on a maximally mixed quantum state for the Hilbert space. In at least one embodiment, determining whether the purity of the first quantum state satisfies the threshold condition includes determining whether a trace determined from the density matrix is greater than or equal to a threshold value defined based on a trace determined for the maximally mixed quantum state (e.g., the trace of the maximally mixed quantum state for a single qubit is

$$\frac{1}{2} ) .$$

In at least one embodiment, the threshold value is defined as the sum of the trace determined for the maximally mixed quantum state and an error value greater than or equal to zero. In at least one embodiment, the purity of the quantum state is computed as Tr[ρ²], where ρ is the density matrix representing the quantum state. In at least one embodiment, the threshold condition is Tr[ρ²]≥δ, where δ is a threshold value that is greater than or equal to the purity of the maximally mixed state. In at least one embodiment, for a single qubit system, the maximally mixed state has purity Tr[ρ²]=½, and the threshold value δ may be set to ½+ε for some small positive value ¿. In at least one embodiment, the threshold condition ensures that the forward diffusion process continues until the quantum state has accumulated sufficient noise to approach the maximally mixed state.

If the purity of the quantum state does not satisfy the threshold condition, this means that enough noise has been added to the quantum state and the forward diffusion process ends. In at least one embodiment, when the forward diffusion process ends, the sequence of density matrices representing the evolution of the quantum state from the initial pure state to the final noisy state is recorded and used as training data for the machine learning model. Otherwise, at operation 646, processing logic modifies the density matrix to obtain a new density matrix representing a new quantum state. In at least one embodiment, modifying the density matrix to obtain the new density matrix includes applying a randomly selected basis measurement to the density matrix. In at least one embodiment, the randomly selected basis measurement corresponds to the x-axis, and the density matrix is updated according to ρ′=(1−ε)ρ+εΦ_X(ρ), where Φ_X(ρ) represents the projection onto the x-basis. In at least one embodiment, the randomly selected basis measurement corresponds to the y-axis, and the density matrix is updated according to ρ′=(1−ε)ρ+εΦ_Y(ρ), where Φ_Y(ρ) represents the projection onto the y-basis. In at least one embodiment, the randomly selected basis measurement corresponds to the z-axis, and the density matrix is updated according to ρ′=(1−ε)ρ+εΦ_Z(ρ), where Φ_Z(ρ) represents the projection onto the z-basis. In at least one embodiment, after applying the monitoring transformation, the density matrix is normalized by dividing by Tr[ρ′²] to ensure proper normalization. In at least one embodiment, the measurement strength parameter & is a constant value that determines the rate at which noise is added to the quantum state at each step.

After modifying the density matrix to obtain the new density matrix, the forward diffusion process then reverts back to operation 644 to determine whether the purity of the new quantum state satisfies the threshold condition. In at least one embodiment, this iterative loop continues until the purity of the quantum state falls below the threshold value, indicating that the quantum state has accumulated sufficient noise. In at least one embodiment, the number of iterations required to reach the threshold condition depends on the measurement strength parameter ε and the initial quantum state. In at least one embodiment, the sequence of density matrices generated during the forward diffusion process represents the gradual evolution of the quantum state from a pure state to a noisy state, which can be used to train the machine learning model to learn the reverse diffusion process. In at least one embodiment, the forward diffusion process uses a POVM, such as a Pauli-6 POVM or a SIC POVM, as described above. In at least one embodiment, a quantum communication channel is divided into a plurality of segments, where noise in each segment of the plurality of segments approximates a weak measurement, as described above. Further details regarding operations 642-646 are described above with reference to FIGS. 4 and 6B.

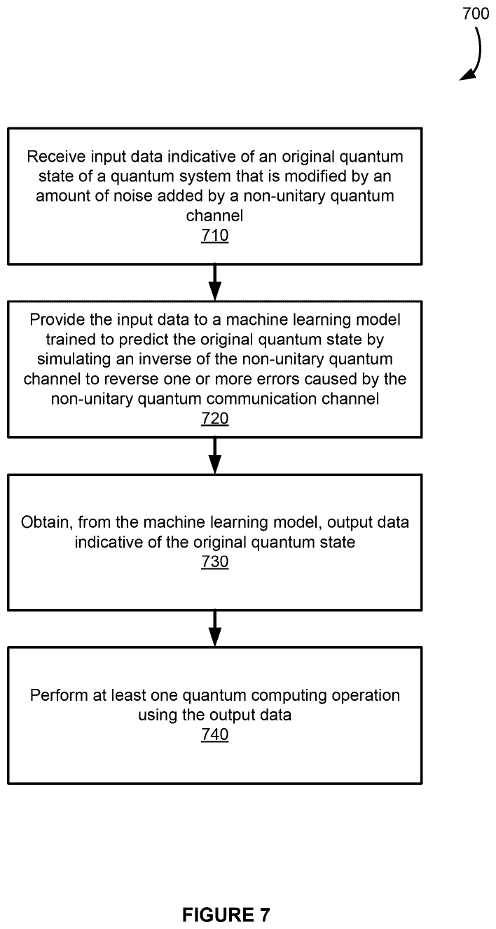

FIG. 7 is a flowchart illustrating an example method for using a trained machine learning model to implement noisy quantum channel error mitigation, in accordance with at least one embodiment. The method 700 can be performed by processing logic that may comprise hardware (e.g., circuitry, dedicated logic, programmable logic, microcode, etc.), software (e.g., instructions run on a processing device to perform hardware simulation), or a combination thereof. In at least one embodiment, the method 700 is performed by the inference component 124B of the computing device 110B described above with reference to FIG. 1B.

At operation 710, processing logic receives input data indicative of an original quantum state of a quantum system that is modified by an amount of noise added by a non-unitary quantum channel. In at least one embodiment, receiving the input data includes processing one or more physical signals (e.g., optical signals, electrical signals, and/or microwave signals) received from the non-unitary quantum channel. For example, the original quantum state can be transmitted by a first quantum computing system, through the quantum channel, to a second quantum computing system. In at least one embodiment, the non-unitary quantum channel is a depolarizing channel that transforms the quantum state according to a probability that the quantum state passes through undisturbed. In at least one embodiment, the non-unitary quantum channel is an amplitude damping channel that models the process by which a qubit loses energy to its environment. In at least one embodiment, the non-unitary quantum channel is a phase damping channel that models the loss of quantum information due to random phase fluctuations. In at least one embodiment, the non-unitary quantum channel is a bit-flip channel that flips the state of a qubit from |0 [symbol] to |1 [symbol] or vice versa with a certain probability.

In at least one embodiment, the input data comprises a plurality of local density matrices, each local density matrix of the plurality of local density matrices corresponding to a respective qubit of an entangled quantum register and obtained by performing a partial trace operation on a global density matrix, as described above.

In at least one embodiment, a quantum communication channel is divided into a plurality of segments, where noise in each segment of the plurality of segments approximates a weak measurement, as described above.

At operation 720, processing logic provides the input data to a machine learning model trained to predict the original quantum state by simulating an inverse of the non-unitary quantum channel to reverse one or more errors caused by the non-unitary quantum communication channel. More specifically, the machine learning model is trained to predict the original quantum state in order to perform error mitigation. In at least one embodiment, the machine learning model is a diffusion model. In at least one embodiment, the machine learning model includes a recurrent neural network, such as an LSTM as described above with reference to FIG. 3. In at least one embodiment, the machine learning model includes an encoder-decoder architecture with a multi-head attention mechanism (e.g., a vision transformer architecture), as described above. In at least one embodiment, the machine learning model includes a U-Net architecture with residual blocks and skip connections, as described above. In at least one embodiment, providing the input data to the machine learning model includes encoding the density matrix as a real-valued tensor by separating real and imaginary components, as described above.

In at least one embodiment, the machine learning model is trained by simulating one or more non-unitary quantum channels, including the non-unitary quantum channel, based on one or more sequences of measurements of one or more quantum states, where each sequence of measurements of a quantum state includes multiple measurements of the quantum state captured in a temporal order. In at least one embodiment, each sequence of measurements of the quantum state is a sequence of weak measurements of the quantum state that does not fully collapse a wave function corresponding to the quantum state. In at least one embodiment, the machine learning model is trained using the forward diffusion process described above with reference to FIGS. 4A, 4B, and 6C, where sequential weak measurements are applied to random pure quantum states until a threshold purity condition is satisfied. In at least one embodiment, the machine learning model is trained using both simulated data and experimental data obtained from actual quantum hardware. In at least one embodiment, the machine learning model is trained using training data comprising a plurality of local density matrices, each local density matrix corresponding to a respective qubit of an entangled quantum register and obtained by performing a partial trace operation on a global density matrix, as described above. In at least one embodiment, the machine learning model is trained to reconstruct a global quantum state from the plurality of local density matrices.

In at least one embodiment, the machine learning model is trained to perform a reverse diffusion process to predict a backward evolution of noise added to the original quantum state by a forward diffusion process. In at least one embodiment, the forward diffusion process includes one or more iterations, wherein each iteration of the one or more iterations of the forward diffusion process is performed by initializing a first quantum state represented by a first density matrix associated with a Hilbert space, determining, based on the density matrix, whether a purity of the first quantum state satisfies a threshold condition defined based on a maximally mixed quantum state for the Hilbert space, and in response to determining that the purity of the first quantum state satisfies the threshold condition, apply a random basis measurement to the first density matrix to obtain a second quantum state associated with a second density matrix. In at least one embodiment, the reverse diffusion process iteratively applies the learned denoising operation to the input data, step by step, to reconstruct the original quantum state from the noisy input. In at least one embodiment, the number of reverse diffusion steps corresponds to the number of forward diffusion steps used during training. In at least one embodiment, the machine learning model is trained using a teacher forcing strategy that transitions gradually to autoregressive generation, using a linear-plateau schedule to anneal a teacher forcing probability, as described above. In at least one embodiment, the machine learning model is trained using a cost function that includes a trace normalization constraint and a penalty for non-Hermitian density matrices, as described above.

At operation 730, processing logic obtains, from the machine learning model, output data indicative of the original quantum state. More specifically, the original quantum state refers to the quantum state of the quantum system prior to being transmitted through the noisy quantum channel. For example, the output data can be indicative of the original state of a qubit transmitted through the noisy quantum channel. For example, the output data can be indicative of the original state of a qubit transmitted through the noisy quantum channel. In at least one embodiment, the output data includes a predicted density matrix corresponding to the original quantum state prior to noise corruption. In at least one embodiment, post-processing is applied to the output data to ensure that the predicted density matrix satisfies the physical constraints of a valid quantum state, including Hermiticity, positive semi-definiteness, and unit trace. In at least one embodiment, the output data is validated using a fidelity metric that measures the overlap between the predicted density matrix and the target density matrix, as described above. In at least one embodiment, the output data is indicative of a global quantum state reconstructed from a plurality of local density matrices, as described above. In at least one embodiment, the output data is used for state preparation of a quantum computing system, as described above.

In at least one embodiment, the input data includes modified message corresponding to an original message modified by the amount of noise, and the output data comprises a prediction of the original message. In at least one embodiment, the input data corresponds to one or more optical qubits obtained by processing optical signals received via the non-unitary quantum channel. For example, the one or more optical qubits can be transferred between computing systems over long distances, and the machine learning model can be used to clean the noisy quantum state before it goes to the next quantum computing system. In at least one embodiment, the machine learning model identifies at least one noise type added by the non-unitary quantum channel. In at least one embodiment, the machine learning model is trained to handle multiple types of noise simultaneously, enabling it to perform error mitigation for quantum channels with complex noise characteristics. In at least one embodiment, the machine learning model can identify whether the noise is primarily depolarizing noise, amplitude damping noise, phase damping noise, or a combination thereof, based on the characteristics of the input data.

At operation 740, processing logic performs at least one quantum computing operation using the output data. In at least one embodiment, the at least one quantum computing operation includes sending, to a quantum computing system, data indicative of the original quantum state predicted by the machine learning model.

In at least one embodiment, the at least one quantum computing operation includes performing quantum sensing and/or metrology to improve measurement precision. For example, the denoised quantum state output can be used to remove noise-induced errors from quantum sensor outputs, thereby enhancing measurement precision.

In at least one embodiment, the at least one quantum computing operation includes performing quantum simulation for generating one or more models with enhanced precision. For example, the error-mitigated quantum state output can be used to extract more accurate expectation values and observables from quantum simulations of complex molecular structures, material properties, and chemical reactions.

In at least one embodiment, the at least one quantum computing operation includes performing at least one quantum cryptography operation. In at least one embodiment, performing at least one quantum cryptography operation includes performing quantum key distribution with enhanced precision. For example, the denoised quantum state output can enable more robust quantum key distribution over longer distances by correcting for channel-induced errors before key extraction.

In at least one embodiment, the at least one quantum computing operation includes performing quantum teleportation, where the output of the machine learning model is used to correct the received quantum state after teleportation, improving the accuracy of quantum state transfer between spatially separated quantum systems. The corrected quantum state output can then be used for subsequent quantum operations at the receiving node.

In at least one embodiment, the at least one quantum computing operation includes facilitating distributed quantum computing, where the denoised quantum state output at each receiving node ensures that subsequent distributed quantum operations proceed with high-fidelity quantum data.

In at least one embodiment, the at least one quantum computing operation comprises executing a quantum algorithm. In at least one embodiment, the at least one quantum computing operation comprises executing a quantum circuit. In at least one embodiment, the method is integrated with a variational quantum algorithm, such as a Variational Quantum Linear Solver (VQLS), as described above.

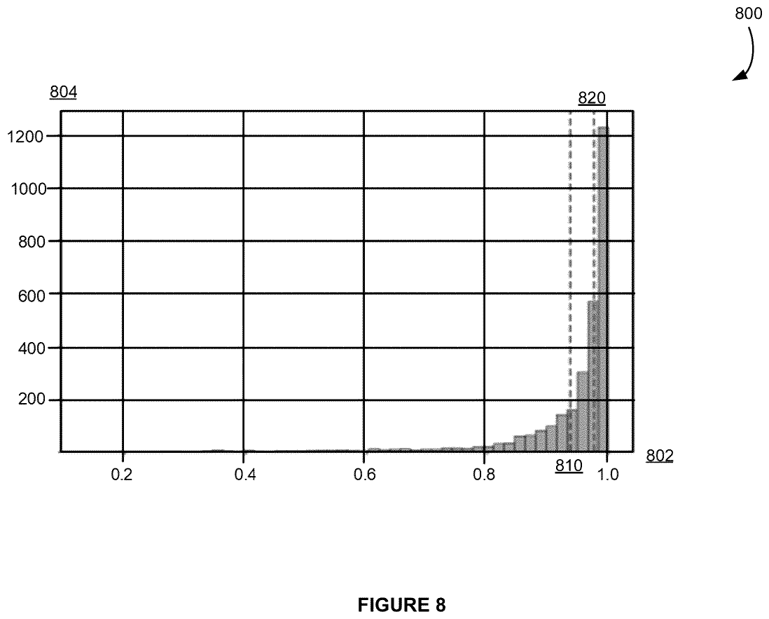

FIG. 8 illustrates a test set fidelity distribution, in accordance with at least at least one embodiment. The test set fidelity distribution 800 depicts a histogram showing the distribution of fidelity values across a test dataset, with the horizontal axis 802 representing fidelity values ranging from about 0.2 to about 1.0 and the vertical axis 804 representing count values ranging from 0 to about 1200. The histogram bars indicate that the majority of test examples achieve high fidelity values concentrated near 1.0, with the tallest bar reaching approximately 1200 counts at the highest fidelity range. A dashed vertical line 810 indicates a mean fidelity value of about 0.9365, and a dashed vertical line 820 indicates a median fidelity value of about 0.9757. The test set fidelity distribution 800 demonstrates a strong skew toward high fidelity values, with relatively few examples exhibiting fidelity values below 0.8, indicating that the trained machine learning model successfully reconstructs quantum states with high accuracy across the test dataset. In at least one embodiment, the test set fidelity distribution 800 corresponds to a validation dataset comprising examples that the machine learning model has not previously encountered during training, thereby demonstrating the generalization capability of the trained model to unseen quantum state data. The fidelity metric used to generate the test set fidelity distribution 800 may correspond to the geometrical fidelity defined as

$$F ( {ρ}^{( true )} , {ρ}^{( p r e d i c t )} ) = \frac{T r ( {ρ}^{( true )} {ρ}^{( p r e d i c t )} )}{\sqrt{T r ( {ρ}^{( true )} {ρ}^{( true ) †} ) Tr ( {ρ}^{( predict )} {ρ}^{( predict ) †} )}} ,$$

which measures the overlap between predicted and target density matrices. In at least one embodiment, the test set fidelity distribution 800 is generated using a dataset comprising 10,000 examples, where 7,000 examples are used for training and 3,000 examples are reserved for validation, with a measurement strength parameter ε=0.15 and a stopping parameter corresponding to a fidelity threshold of [symbol] =0.7. The concentration of fidelity values near 1.0 in the test set fidelity distribution 800 indicates that the machine learning model effectively learns the inverse dynamics of the noisy quantum channel, enabling accurate reconstruction of original quantum states from noisy input data. In at least one embodiment, the difference between the mean fidelity value and the median fidelity value in the test set fidelity distribution 800 reflects the presence of a small number of outlier examples with lower fidelity values, which may correspond to quantum states that are particularly challenging to reconstruct due to their proximity to the maximally mixed state or other factors affecting the learning process.

FIG. 9A illustrates a tensor-network representation of a separable quantum register tensor network 900A, wherein independently parameterized subsystem states are propagated through local tensor operations without inter-subsystem coupling, in accordance with at least one embodiment. The separable quantum register tensor network 900A includes two parallel single qubit tensor networks 910A and 920A that operate independently without any coupling between them. This architecture reflects the mathematical structure of separable quantum states, where each local subsystem evolves under its own quantum channel without influence from other subsystems.

The single qubit tensor network 910A begins with a local pure state 912A characterized by angular parameters θ₁ and φ₁, which parameterize the qubit state on the Bloch sphere according to |ψ₁ [symbol] =cos (θ₁/2)|0 [symbol] +sin (θ₁/2)e^{iφ}^{₁}|1 [symbol] . The local pure state 912A feeds into a tensor operation block 914A, which receives a local feedback 915A from an external input representing a weak measurement operation applied to the qubit. The tensor operation block 914A may implement the monitoring transformation [symbol] (ρ)=(1−∈)ρ+∈Φ_{Â}(ρ) described above, where the local feedback 915A may specify the measurement basis and strength for that particular time step. The output of the tensor operation block 914A then flows to a tensor operation block 916A, which may similarly receive a local feedback 917A representing a subsequent weak measurement operation. The tensor operation block 916A outputs to a tensor operation block 918A, which receives a local feedback and produces a first output connection 919A at the bottom of the network. Each successive tensor operation block represents an additional time step in the forward diffusion process, with the accumulated effect of multiple weak measurements gradually transforming the pure state toward a mixed state.

The single qubit tensor network 920A may operate in parallel with the single qubit tensor network 910A and begin with a local pure state 922A characterized by angular parameters θ₂ and φ₂. The local pure state 922A feeds into a tensor operation block 924A, which receives a local feedback 925A. The output flows to a tensor operation block 926A, which receives a local feedback 927A. The tensor operation block 926A outputs to a tensor operation block 928A, which receives a local feedback and produces a second output connection 929A at the bottom of the network. The parallel structure of the two single qubit tensor networks 910A and 920A reflects the independence of the local quantum channels, where the weak measurements applied to one qubit do not affect the evolution of the other qubit.

The separable quantum register tensor network 900A demonstrates a structure where each qubit evolves locally through its respective sequence of tensor operation blocks without any cross-interactions between the two single qubit tensor networks 910A and 920A. The local feedback connections may represent inputs to each tensor operation block that influence the transformation applied at each stage, corresponding to the randomly selected measurement basis (e.g., x, y, or z basis from the Pauli-six POVM) applied during each iteration of the forward diffusion process. This architecture enables the quantum register to be written as a tensor product of the individual qubit states, allowing the number of features to increase linearly with the number of qubits rather than exponentially. Specifically, for a separable quantum register with d qubits, the input features of the machine learning model have the shape [N, S, d, 2, 2, 2], which can be converted to [N, S, 8d] features, where Nis the batch size, Sis the sequence length, and 8d represents the real and imaginary components of each 2×2 density matrix for all d qubits. In at least one embodiment, this separable representation is used when the quantum states being processed do not exhibit entanglement between subsystems, such as in quantum computing applications where qubits are prepared and manipulated independently before any entangling operations are applied.

FIG. 9B illustrates a tensor-network architecture in which initially separable local tensor states are transformed into non-separable tensors, in accordance with at least one embodiment. The non-separable quantum register tensor network 900B includes three single qubit tensor networks 910B, 920B, and 930B that are coupled through a multi-qubit entangling operator layer 905B, which introduces entanglement between the previously independent subsystems. This architecture represents the more general case where quantum correlations exist between different qubits in the register, where the machine learning model processes the full global density matrix rather than individual local density matrices.

The single qubit tensor network 910B is associated with angular parameters θ₁ and φ₁, and includes a local pure state 912B that feeds into the multi-qubit entangling operator layer 905B. Below the multi-qubit entangling operator layer 905B, the single qubit tensor network 910B includes a tensor operation block 914B that receives a local feedback 915B, and a tensor operation block 916B positioned below that receives a local feedback 917B. The tensor operation blocks 914B and 916B are connected in series, with outputs flowing downward from the tensor operation block 916B. Although the noise channels implemented by the tensor operation blocks act locally on each qubit, the global quantum state maintains correlations introduced by the entangling operations, meaning that the local evolution of one qubit affects the reduced density matrix of other qubits through the shared entanglement.

The single qubit tensor network 920B is associated with angular parameters θ₂ and φ₂, and includes a local pure state 922B that feeds into the multi-qubit entangling operator layer 905B. Below the multi-qubit entangling operator layer 905B, the single qubit tensor network 920B includes a tensor operation block 924B that receives a local feedback 925B, and a tensor operation block 926B positioned below that receives a local feedback 927B.

The single qubit tensor network 930B is associated with angular parameters θ₃ and φ₃, and includes a local pure state 932B that feeds into the multi-qubit entangling operator layer 905B. Below the multi-qubit entangling operator layer 905B, the single qubit tensor network 930B includes a tensor operation block 934B that receives a local feedback 935B, and a tensor operation block 936B positioned below that receives a local feedback 937B.

The multi-qubit entangling operator layer 905B serves as a coupling mechanism that connects the three local pure states 912B, 922B, and 932B, enabling the generation of entangled quantum states through controlled-NOT gate operations applied between randomly selected pairs of qubits. In at least one embodiment, the multi-qubit entangling operator layer 905B applies m controlled-NOT gates between randomly selected pairs of qubits, where each controlled-NOT gate can be represented in tensor notation as

$${CNOT}_{i j}^{q r} = {\sum }_{m} {COPY}_{i}^{q m} \cdot {XOR}_{m j}^{r} ,$$

with the COPY operator duplicating the control qubit state and the XOR operator performing the conditional bit flip on the target qubit. After the entanglement is established through the multi-qubit entangling operator layer 905B, local noise channels implemented by the tensor operation blocks process each qubit independently while maintaining the global correlations introduced by the entangling operations. The local feedback connections represent the iterative application of weak measurement operations to each subsystem during the forward diffusion process used to generate training data for machine learning models performing quantum error mitigation. For non-separable quantum states with d qubits, the input features of the machine learning model have the shape [N, S, 2, 2^{d}, 2^{d}], which can be converted to [N, S, 2^{2d+1}] features, reflecting the exponential scaling of the Hilbert space dimension with the number of qubits. In at least one embodiment, the non-separable representation is used when the quantum states being processed exhibit entanglement between subsystems, which may occur in quantum computing applications involving multi-qubit gates or quantum communication protocols. In at least one embodiment, the machine learning model is trained on local density matrices obtained by performing partial traces over the global density matrix, represented as ρᵢ=Tr_{j≠i}(ρ). This may reduce the number of input features, but may result in a more challenging learning task due to the loss of correlation information between qubits, hence leading to overfitting.

In at least one embodiment, a machine learning model is trained using only local density matrices to reconstruct global quantum states. More specifically, in each time step, each local density matrix may be calculated by performing a partial trace operation on the global density matrix to trace out all qubits except the qubit of interest. The model may then be trained on the local evolutions of these individual qubit density matrices. This approach is more realistic and challenging because the local density matrices lack information about correlations between qubits. Despite the reduced input information, the model may be trained to predict the initial global density matrix from the local density matrix evolutions.

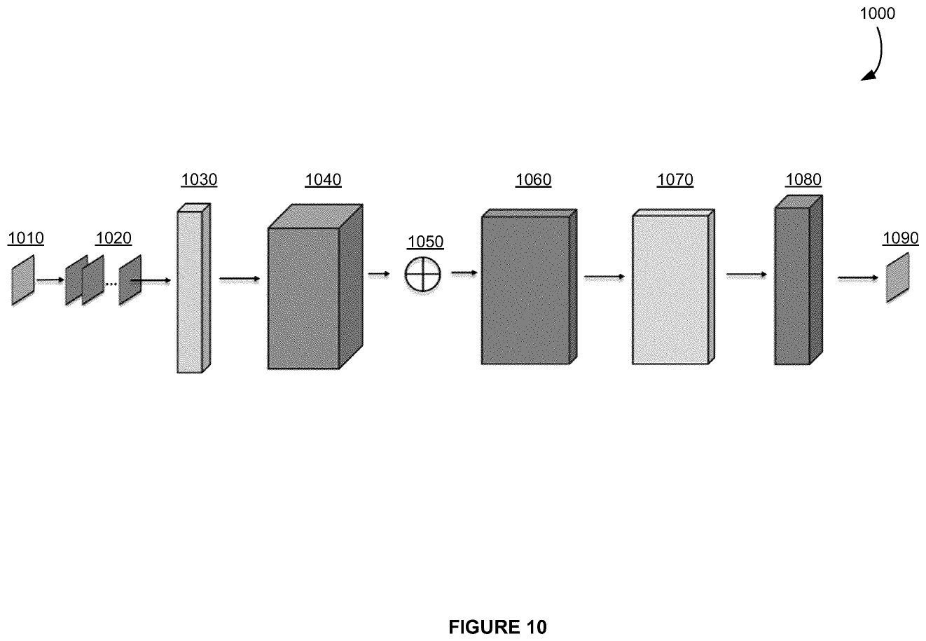

FIG. 10 illustrates a vision transformer architecture 1000 that can be used to implement noisy quantum data error mitigation, in accordance with at least one embodiment. The vision transformer architecture 1000 may be employed as an alternative to recurrent neural network architectures for processing quantum state representations, particularly when capturing non-local correlations and long-range dependencies in the data may be beneficial for the error mitigation process. Unlike recurrent neural networks such as LSTMs, which process sequential data through iterative hidden state updates, vision transformers employ self-attention mechanisms that can directly model relationships between any pair of elements in the input sequence, potentially enabling more efficient capture of the complex correlations present in quantum state data. The vision transformer architecture 1000 may be particularly advantageous for processing quantum states in high-dimensional Hilbert spaces, where the number of parameters scales exponentially with the number of qubits and where convolutional or recurrent approaches may require prohibitively deep networks to achieve comparable receptive field sizes.

The vision transformer architecture 1000 receives an input tensor 1010 representing quantum state data to be processed. In at least one embodiment, the input tensor 1010 may represent a sequence of density matrices corresponding to the evolution of a quantum state through a noisy quantum channel, with each density matrix encoded as a real-valued tensor by separating real and imaginary components. For example, for a quantum register with d qubits in a non-separable configuration, the input tensor 1010 may have the shape [N, S, 2, 2^{d}, 2^{d}], where N is the batch size, Sis the sequence length corresponding to the number of time steps in the forward diffusion process, and the remaining dimensions encode the real and imaginary components of the 2^{d}×2^{d} density matrix. The input tensor 1010 is provided to patch embedding layers 1020, which divide the input data into patches and embed them into a suitable representation for transformer processing. In the context of quantum state data, the patch embedding layers 1020 may segment the density matrix representation into smaller components that can be processed by the transformer architecture, analogous to how image patches are extracted in standard vision transformer applications. In at least one embodiment, the patch embedding layers 1020 extract non-overlapping patches from the density matrix representation, where each patch corresponds to a subset of the matrix elements that encode correlations between specific subsets of qubits.

The patch embedding layers 1020 are connected to a linear projection layer 1030, which projects the embedded patches into a higher-dimensional feature space suitable for the transformer encoder. The linear projection layer 1030 may implement a learned linear transformation that maps each patch to a fixed-dimensional embedding vector, enabling the transformer to process patches of varying sizes in a uniform manner. The linear projection layer 1030 feeds into a transformer encoder block 1040, which processes the projected features through attention mechanisms. A position encoding block 1050 adds positional information to the features, enabling the transformer to understand the spatial or sequential relationships within the data. In the context of quantum error mitigation, the position encoding block 1050 may encode temporal information corresponding to the sequence of weak measurements or the time steps of the forward diffusion process, allowing the model to distinguish between density matrices at different stages of the noise evolution. In at least one embodiment, the position encoding block 1050 implements learnable position embeddings that are added to the patch embeddings, enabling the model to learn optimal positional representations for the quantum state data during training.

The position encoding block 1050 combines with the output of the transformer encoder block 1040 and feeds into a transformer block 1060, which applies multi-head self-attention and feed-forward operations to capture dependencies across the input data. The multi-head self-attention mechanism may enable the vision transformer architecture 1000 to identify correlations between different components of the quantum state representation, which may be useful for reconstructing the original quantum state from noisy observations. In particular, the self-attention mechanism computes attention weights that determine how much each element of the input sequence should attend to every other element, enabling the model to capture both local and global dependencies without the sequential processing constraints of recurrent architectures. The attention operation may be expressed as

$$Attention ( Q , K , V ) = softmax ( \frac{Q {K}^{T}}{\sqrt{{d}_{k}}} ) V ,$$

where Q, K, and V represent query, key, and value matrices derived from the input features, and dₖ is the dimension of the key vectors. This capability may be particularly advantageous for processing entangled quantum states, where correlations between distant qubits may be important for accurate error mitigation. For non-separable quantum states generated through the application of controlled-NOT gates as described with reference to FIG. 9B, the self-attention mechanism may learn to identify and preserve the entanglement structure when reconstructing the original quantum state from noisy observations. In at least one embodiment, the transformer block 1060 includes multiple layers of multi-head self-attention followed by feed-forward networks, with residual connections and layer normalization applied after each sub-layer to facilitate gradient flow during training.

The transformer block 1060 is followed by a layer normalization block 1070, which normalizes the activations to stabilize training and improve convergence. The layer normalization block 1070 applies normalization across the feature dimension for each position independently, which may be more suitable for variable-length sequences than batch normalization. In at least one alternate embodiment, batch normalization is applied instead of layer normalization.

The layer normalization block 1070 connects to a projection head block 1080, which maps the processed features to the target output dimensionality for the error mitigation task. In at least one embodiment, the projection head block 1080 includes one or more fully connected layers that transform the transformer output to match the dimensionality of the target density matrix representation. The projection head block 1080 produces an output tensor 1090 representing the denoised or error-mitigated quantum state data. In at least one embodiment, the output tensor 1090 may represent a predicted density matrix corresponding to the original quantum state prior to noise corruption, with the real and imaginary components reconstructed from the model output and combined to form a valid Hermitian density matrix. Post-processing may be applied to the output tensor 1090 to ensure that the predicted density matrix satisfies the physical constraints of a valid quantum state, including Hermiticity, positive semi-definiteness, and unit trace.

In at least one embodiment, the vision transformer architecture 1000 is trained using the same training data and loss functions described above for the LSTM architecture, including the mean squared error loss term L_{MSE} and the fidelity loss term L_{FID} that measures similarity between predicted and target density matrices. The training data may be generated using the forward diffusion process described with reference to FIGS. 4A-4B, where sequential weak measurements are applied to random pure quantum states until a threshold purity condition is satisfied. The vision transformer architecture 1000 may offer advantages in processing quantum state data with complex correlations, as the self-attention mechanism can capture long-range dependencies without the sequential processing constraints of recurrent architectures. The computational complexity of self-attention scales quadratically with the sequence length, expressed as O(N²) where N is the number of spatial positions. However, by applying attention at reduced spatial resolutions (e.g., at a bottleneck layer), this computational cost may be significantly reduced while still enabling the model to learn global dependencies. Additionally, the vision transformer architecture 1000 may be more amenable to parallel computation during training and inference, potentially enabling faster processing of large datasets or high-dimensional quantum state representations. The parallelizable nature of the attention computation, in contrast to the inherently sequential nature of recurrent architectures, may enable more efficient utilization of GPU resources during training. In some cases, the vision transformer architecture 1000 is combined with recurrent components to form a hybrid architecture that leverages the strengths of both approaches, using attention mechanisms to capture global correlations while employing recurrent connections to model the temporal dynamics of the noise evolution process. In at least one embodiment, the vision transformer architecture 1000 is combined with an encoder-decoder structure similar to a U-Net architecture, where the encoder progressively reduces spatial dimensions while increasing feature channels, the bottleneck applies multi-head self-attention to capture long-range spatial dependencies, and the decoder reconstructs the denoised quantum state at the original resolution using skip connections to preserve high-resolution details and phase information.

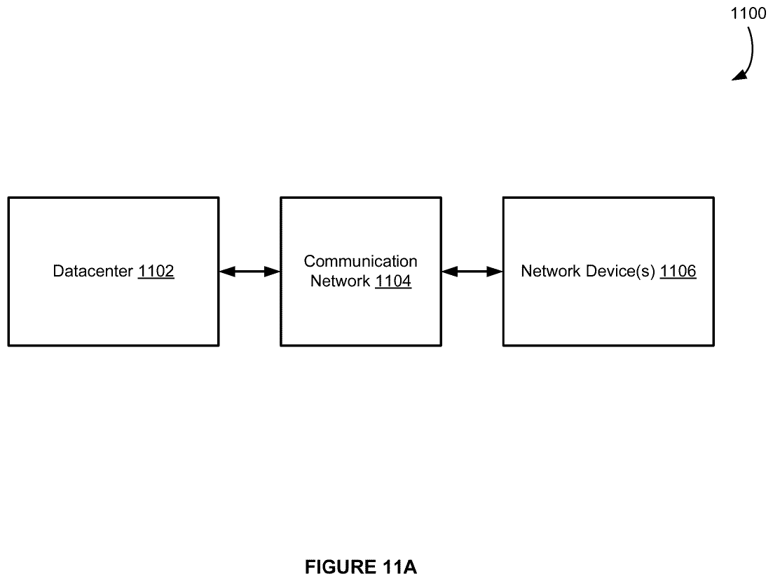

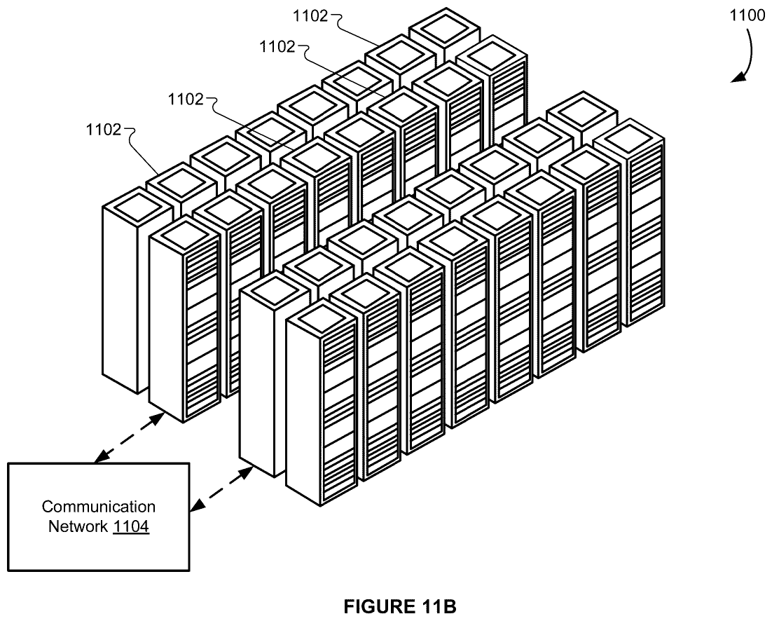

FIGS. 11A-1B are diagrams illustrating a network architecture 1100 that can be used to implement quantum communication protocols, in accordance with at least one embodiment. For example, the network architecture 1100 may include a datacenter 1102, a communication network 1104, and network device(s) 1106. The network architecture 1100 may illustrate a general computing architecture within which more specific systems and/or subsystems may function.

For example, the datacenter 1102 may be a centralized facility designed to house computing resources and related components. The datacenter 1102 may operate to support the infrastructure required for advanced computational tasks, for efficient, secure, and reliable operations. The datacenter 1102 may include the building and structural components, including power supplies, cooling systems, fire suppression systems, and physical security measures that are configured to maintain optimal operating conditions and/or protect the equipment from environmental hazards and unauthorized access. The datacenter 1102 may include high-performance servers or compute nodes, often arranged in racks as shown in network architecture 1100, and connected through high-speed networks as described herein. These servers may include processors referred also in the present disclosure as processing device (e.g., central processing units (CPUs), graphics processing units (GPUs), data processing units (DPUs) and/or the like), quantum processing units (QPUs), a plurality of parallel processing units (PPUs), and application-specific integrated circuits (ASICs). memory (e.g., RAM), and storage solutions (e.g., hard disk drives (HDDs), solid state drives (SSDs), and/or the like. The hardware configuration may be designed for parallel processing and high throughput, catering to the demands of high-performance computing (HPC) applications. QPUs configured to perform one or more operations associated with a quantum algorithm In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with.

The datacenter 1102 may include high-speed network equipment, such as network switches, routers, firewalls, and/or the like to facilitate fast and secure data transmission within the datacenter 1102 (e.g., between the servers or compute nodes) and between external networks. The datacenter 1102 may facilitate communication between servers or compute nodes through a network topology that ensures efficient data exchange, minimizes latency, and maximizes bandwidth. The network topology may dictate how various network devices, such as switches and routers, are interconnected for data flow. By implementing an effective network topology, the datacenter 1102 may support high-performance computing tasks. Examples of various network topologies may include hierarchical networking topologies such as the fat tree topology, Slim Fly topology, Dragonfly topology, and/or the like.

The communication network 1104 may communicably couple the datacenter 1102 with network device(s) 1106 and other external devices for data exchange and connectivity. Examples of the communication network 1104 may include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. The ability of the communication network 1104 to incorporate multiple network types and configurations may allow the datacenter 1102 to adapt to diverse application needs, from general data communication to specialized HPC tasks. As described herein, the communication network 1104 may leverage various optical components to establish communication links (e.g., communicably couple) between components in the architecture 1100. As such, the communication network 1104 may include various optical devices, transceivers, modules, and/or the like that are configured to generate optical signals (e.g., provide optical transmitter functionality) and/or receive optical signals (e.g., provide optical receiver functionality).

The network device(s) 1106 may include a variety of computing devices capable of transmitting and receiving signals over the communication network 1104. The network device(s) 1106 may range from personal computing devices to complex server configurations. Examples include Personal Computers (PCs), laptops, tablets, smartphones, and servers. The network device(s) 1106 may facilitate user interactions with the datacenter 1102, allowing for data input, retrieval, and processing from remote locations. In addition to individual computing devices, the network device(s) 1106 may also include collections of servers or additional datacenters. For instance, these could be other datacenters similar to or the same as datacenter 1102. Such an interconnection may allow for the formation of a distributed computing environment for improved redundancy, load balancing, and disaster recovery capabilities. By linking multiple datacenters, the network architecture 1100 may leverage geographically dispersed resources, optimizing performance and ensuring high availability.

As described herein, the datacenter 1102 and/or the network device(s) 1106 may include storage devices and processing circuitry for executing computing tasks, such as controlling the flow of data internally and over the communication network 1104. The processing circuitry may include software, hardware, or a combination thereof. For example, the processing circuitry may include a memory containing executable instructions and a processor (e.g., a microprocessor) that executes these instructions. The memory may correspond to any suitable type of memory device or collection of memory devices configured to store instructions. Non-limiting examples of suitable memory devices include Flash memory, Random Access Memory (RAM), Read Only Memory (ROM), variants thereof, combinations thereof, or similar technologies. In specific embodiments, the memory and processor may be integrated into a common device, such as a microprocessor with integrated memory. Additionally, or alternatively, the processing circuitry may comprise hardware components, such as an application-specific integrated circuit (ASIC). Other non-limiting examples of processing circuitry include Integrated Circuit (IC) chips, CPUs, GPUs, microprocessors, Field Programmable Gate Arrays (FPGAs), collections of logic gates or transistors, resistors, capacitors, inductors, and diodes. Some or all of the processing circuitry may be provided on a Printed Circuit Board (PCB) or a collection of PCBs. It should be appreciated that any appropriate type of electrical component or collection of electrical components may be suitable for inclusion in the processing circuitry.

Each network device 1106 may include or be connected to a power distribution unit (PDU) that supplies power to power consuming elements of the network devices 1106 (e.g., to the individual network switches within each network device). Related art PDUs may take the form of many power interfaces (e.g., AC and/or DC power outlets) integrated into a single power strip, which requires cumbersome power cable routing and complicated assembly/disassembly. In addition, these power strips cannot be easily replaced. For example, replacement or repair of one or a few of the outlets of the PDU or other elements of the PDU may require powering off the entire strip and disconnecting each power cable before installing a new power strip and reconnecting the power cables to each outlet. This process is time consuming and may result in unnecessary replacement of functioning parts of the PDU that are integrated with non-functioning parts of the PDU. In order to address these and other shortcomings of the related art, example embodiments provide PDUs capable of blind-mating or direct connection with power consuming elements within the network devices 1106. In addition, PDUs according to example embodiments may be modular and function together to provide power to consumers so that replacement or repair of one non-functioning PDU module does not interrupt power to consumers of the network device connected to functioning PDU modules.

In addition, although not explicitly shown, the present disclosure contemplates that the datacenter 1102 and network device(s) 1106 may include one or more communication interfaces for facilitating wired and/or wireless communication between one another and other unillustrated elements of the network architecture 1100. These communication interfaces may include a variety of technologies, including but not limited to Ethernet ports, fiber optic connections, Wi-Fi® transceivers, Bluetooth® modules, and cellular communication modules for integration and interoperability among the various components within the network architecture 1100.

Furthermore, the present disclosure contemplates that the network architecture 1100 may include additional components and functionalities. For example, the network architecture may include, without limitation, additional processing units, specialized accelerators (such as Tensor Processing Units or TPUs), enhanced security modules, and redundant power supplies. The inclusion of these elements may be intended to ensure that the network architecture 1100 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the network architecture 1100.

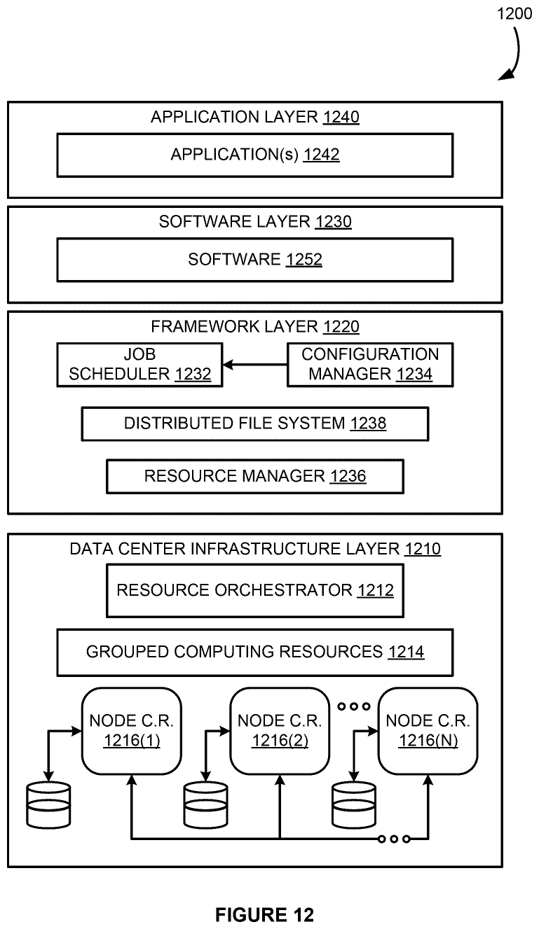

FIG. 12 illustrates a datacenter 1200, in accordance with at least one embodiment. In at least one embodiment, datacenter 1200 includes, without limitation, a datacenter infrastructure layer 1210, a framework layer 1220, a software layer 1230 and an application layer 1240.

In at least one embodiment, datacenter infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (“CPUs”) or other processors (including accelerators, field programmable gate arrays (“FPGAs”), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1216(1)-1216(N) may be a server having one or more of above-mentioned computing resources.

In at least one embodiment, grouped computing resources 1214 may include separate groupings of node C.R.s housed within one or more racks (not shown), or many racks housed in datacenters at various geographical locations (also not shown). Separate groupings of node C.R.s within grouped computing resources 1214 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1212 may configure or otherwise control one or more node C.R.s 1216(1)-1216(N) and/or grouped computing resources 1214. In at least one embodiment, resource orchestrator 1212 may include a software design infrastructure (“SDI”) management entity for datacenter 1200. In at least one embodiment, resource orchestrator 1212 may include hardware, software or some combination thereof.

In at least one embodiment, framework layer 1220 includes, without limitation, a job scheduler 1232, a configuration manager 1234, a resource manager 1236 and a distributed file system 1238. In at least one embodiment, framework layer 1220 may include a framework to support software 1252 of software layer 1230 and/or one or more application(s) 1242 of application layer 1240. In at least one embodiment, software 1252 or application(s) 1242 may respectively include web-based service software or applications, such as those provided by a cloud service provider. In at least one embodiment, framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1232 may include a Spark driver to facilitate scheduling of workloads supported by various layers of datacenter 1200. In at least one embodiment, configuration manager 1234 may be capable of configuring different layers such as software layer 1230 and framework layer 1220, including Spark and distributed file system 1238 for supporting large-scale data processing. In at least one embodiment, resource manager 1236 may be capable of managing clustered or grouped computing resources mapped to or allocated for support of distributed file system 1238 and job scheduler 1232. In at least one embodiment, clustered or grouped computing resources may include grouped computing resource 1214 at datacenter infrastructure layer 1210. In at least one embodiment, resource manager 1236 may coordinate with resource orchestrator 1212 to manage these mapped or allocated computing resources.

In at least one embodiment, software 1252 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. In at least one or more types of applications may include, without limitation, CUDA applications, 5G network applications, artificial intelligence application, datacenter applications, and/or variations thereof.

In at least one embodiment, any of configuration manager 1234, resource manager 1236, and resource orchestrator 1212 may implement any number and type of self-modifying actions based on any amount and type of data acquired in any technically feasible fashion. In at least one embodiment, self-modifying actions may relieve a datacenter operator of datacenter 1200 from making possibly bad configuration decisions and possibly avoiding underutilized and/or poor performing portions of a datacenter.

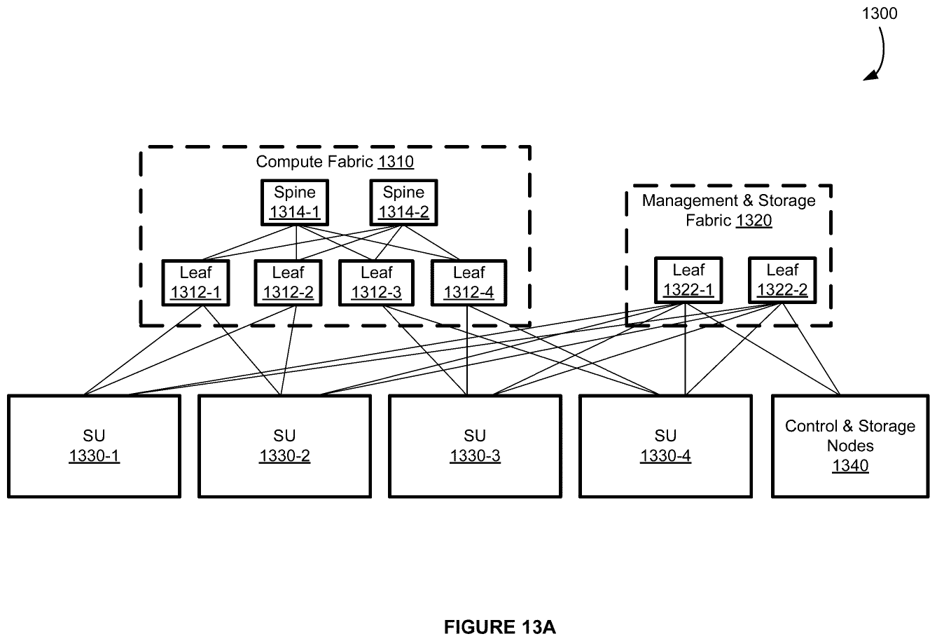

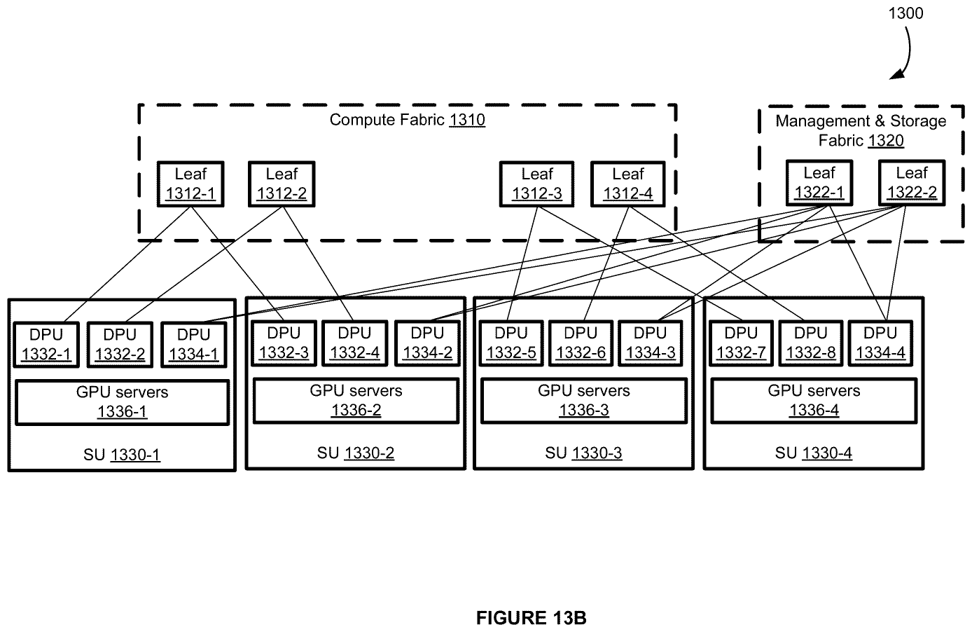

FIGS. 13A-13B depict a data center architecture (“architecture”) 1300, in accordance with at least one embodiment. The architecture 1300 can represent a cluster include servers and corresponding graphics processing units (GPUs). For example, the architecture 1300 can represent the OVX L40S GPU Cluster provided by NVIDIA®. The cluster can include 128 servers totaling 512 GPUs by default. However, the architecture 1300 is scalable, and can be expanded up to 2048 GPUs with minimal impact on performance scaling. The architecture 1300 is organized into 16 server racks (e.g., OVX L40S GPU server racks), one leaf & spine switch rack, and two management & storage racks. Each server rack can contain 8 compute server nodes, with each node equipped with 4 L40S GPUs, providing high-density GPU resources per rack. The cluster configuration can include 12 control server nodes and 12 storage server nodes, ensuring robust management and data handling capabilities. The default rack layout, featuring a single leaf & spine switch rack, assumes the presence of power supply redundancy within each rack. Otherwise, an alternative rack layout can be considered to maintain system reliability. The number of servers per rack can be determined by the available rack power, ensuring safe and efficient operation. Each server can be provisioned with a single-node bandwidth of 2×200 Gbps, and the network is designed to be flexible and scalable to accommodate increasing capacity and bandwidth requirements.

For example, the architecture 1300 can include servers interconnected via a compute fabric 1310 (e.g., Spectrum-X 400G compute fabric). The compute fabric 1310 implements a leaf-spine network topology designed for high performance, utilizing rail-optimized, non-blocking 128-port leaf switches 1312-1 through 1312-4, and spine switches 1314-1 and 1314-2. The leaf switches 1312-1 through 1312-4 provide 64 downlinks and 64 uplinks to scalable units (SUs) 1330-1 through 1330-4, where each SU can include 4 racks and 32 GPU nodes. The spine switches 1314-1 and 1314-2 are the core backbone switches connecting the leaf switches 1312-1 through 1312-4. The leaf switches 1312-1 through 1312-4 provide aggregate connections from GPU nodes to the spin switches 1314-1 and 1314-2. This architecture supports high throughput and low-latency communication between nodes. The compute fabric 1310 can employ a full non-blocking fat tree topology, which is optimal for high-performance applications, and is based on a RDMA (Remote Direct Memory Access) technology to minimize latency and maximize bandwidth.

The leaf-spine network topology implemented by the compute fabric 1310, in conjunction with rail-optimized Data Processing Units (DPUs), which can implement SmartNICs to provide hardware acceleration for network and storage functions, can be designed to provide the shortest and most efficient network paths for GPU-to-GPU communication, both within individual nodes and across multiple nodes. This architecture is highly effective for multi-GPU workloads and supports both top-of-rack (ToR) and end-of-row (EoR) switch configurations, enabling flexible deployment options to accommodate a variety of data center layouts. The compute fabric 1310 delivers a scalable and robust network infrastructure, capable of supporting clusters ranging from small to very large sizes, while maintaining predictable and consistent performance. The compute fabric 1310 can be engineered to maximize aggregate bandwidth and minimize network latency for GPU interconnects, both within a server and across rails, by leveraging high-speed, low-latency switching and optimized routing algorithms.

As another example, for management and storage, the architecture 1312 can include a management & storage fabric 1320 (e.g., a 200G Ethernet in-band management & storage fabric). The management & storage fabric 1320 can support High Availability (HA) by utilizing two 128-port leaf switches 1322-1 and 1322-2. All nodes are redundantly connected to both leaf switches 1322-1 and 1322-2, ensuring uninterrupted operation in the event of a switch failure. The management & storage fabric 1320 is architecturally independent from the compute fabric 1310, which allows for the optimization of both storage and application performance. For example, in addition to connections to the SUs 1330-1 through 1330-4, the leaf switches 1322-1 and 1322-2 can be connected to control and storage nodes 1340. In a typical configuration, there may be 12 control nodes and 12 storage nodes. Cluster provisioning and orchestration can be managed by the Base Command Manager (BCM), which is responsible for provisioning all server nodes and network devices. The BCM supports automated deployment of Kubernetes or SLURM (Simple Linux Utility for Resource Management) clusters, enabling dynamic resource management, workload scheduling, and rapid scaling of cluster resources.

For example, as illustrated in FIG. 13B, SU 1330-1 can include DPUs 1332-1 and 1332-2 for its GPU network, DPU 1334-1 for its CPU network, and GPU servers 1336-1. SU 1330-2 can include DPUs 1332-3 and 1332-4 for its GPU network, DPU 1334-2 for its CPU network, and GPU servers 1336-2. SU 1330-3 can include DPUs 1332-5 and 1332-6 for its GPU network, DPU 1334-3 for its CPU network, and GPU servers 1336-3. SU 1330-4 can include DPUs 1332-7 and 1332-8 for its GPU network, DPU 1334-4 for its CPU network, and GPU servers 1336-4. Each DPU can implement a SmartNIC, providing hardware acceleration for network and storage functions. With respect to compute fabric 1310, leaf switch 1312-1 can be connected to DPUs 1332-1 and 1332-3, leaf switch 1312-2 to DPUs 1332-2 and 1332-4, leaf switch 1312-3 to DPUs 1332-5 and 1332-7, and leaf switch 1312-4 to DPUs 1332-6 and 1332-8. For the management & storage fabric 1320, leaf switches 1322-1 and 1322-2 can each be connected to DPUs 1334-1 through 1334-4. Although not depicted in FIG. 13B, each of the SUs 1330-1 through 1330-4 can include a respective Intelligent Platform Management Interface (IPMI), and each of the leaf switches 1322-1 and 1322-2 can be connected to each of the IPMIs. Although not depicted in FIGS. 13A-B, the control & storage nodes 1340 can include a storage node, a control node and an IPMI, and each of the leaf switches 1322-1 and 1322-2 can be connected to the storage node, the control node and the IPMI.

For inference workloads, an East/West (E/W) network is typically not required, as most pre-trained models can be accommodated within the memory of a single GPU. However, models that exceed approximately 13 B parameters may require model parallelism and the use of multiple GPUs, in which case E/W network connectivity may become necessary. For typical inference use cases, the E/W network can be omitted, simplifying the network design and reducing cost and complexity. It is important to note that while tensor parallelism enables the distribution of large models across multiple GPUs, it can result in lower performance compared to running models entirely on a single GPU due to increased communication overhead. Supported model sizes for optimal performance are generally up to 13 B parameters, although larger models may be supported with appropriate parallelization strategies and network design.

Inference and prediction tasks within the cluster are highly dynamic, often requiring auto-scaling of compute engines and inference server instances. Fine-tuning can be used to optimize which models are loaded on which inference servers, ensuring efficient resource utilization and rapid response to changing workload demands. Additional technical considerations may include monitoring GPU utilization, managing model versioning, and implementing load balancing strategies to further enhance inference performance and reliability.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously, or intermittently. In at least one embodiment, terms “system” and “method” are used herein interchangeably insofar as the system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising:
a memory; and
at least one processing device, operatively coupled with the memory, to:
provide, to a machine learning model, input data indicative of an original quantum state of a quantum system that is modified by an amount of noise added by a non-unitary quantum communication channel, wherein the machine learning model is trained to predict the original quantum state in order to perform error mitigation by simulating an inverse of the non-unitary quantum communication channel to reverse one or more errors caused by the non-unitary quantum communication channel;
obtain, from the machine learning model, output data indicative of the original quantum state; and
cause a quantum computing system to perform at least one quantum computing operation, involving at least one of error mitigation or quantum state preparation, based on the output data.

2. The system of claim 1, wherein the machine learning model is a diffusion model.

3. The system of claim 1, wherein the machine learning model comprises a recurrent neural network or an encoder-decoder network.

4. The system of claim 1, wherein the machine learning model is trained to perform a reverse diffusion process to predict a backward evolution of noise added to the original quantum state in accordance with a forward diffusion process.

5. The system of claim 4, wherein the forward diffusion process comprises one or more iterations, and wherein each iteration of the one or more iterations of the forward diffusion process is performed by:
initializing a first quantum state represented by a first density matrix associated with a Hilbert space;
determining, based on the density matrix, whether a purity of the first quantum state satisfies a threshold condition defined based on a maximally mixed quantum state for the Hilbert space; and
in response to determining that the purity of the first quantum state satisfies the threshold condition, modifying the first density matrix to obtain a second density matrix representing a second quantum state.

6. The system of claim 1, wherein the machine learning model comprises a vision transformer architecture that segments a density matrix representation of the quantum state into a plurality of patches, and wherein each patch of the plurality of patches is embedded into a feature representation for spatial correlation learning across the density matrix.

7. The system of claim 1, wherein the at least one quantum computing operation comprises at least one of: executing a quantum algorithm or initializing the quantum computing system with the original quantum state.

8. The system of claim 1, wherein the at least one processing device is further to cause the quantum system to be coupled to an ancillary quantum system to implement a unitary operation that approximates the inverse of the non-unitary quantum channel, and wherein a partial trace operation is performed over the ancillary quantum system.

9. The system of claim 1, wherein the input data comprises a modified message corresponding to an original message modified by the amount of noise, and wherein the output data comprises a prediction of the original message.

10. The system of claim 1, wherein the machine learning model is used to identify a noise type added by the non-unitary quantum communication channel.

11. The system of claim 1, wherein the input data corresponds to one or more optical qubits.

12. The system of claim 1, wherein the at least one processing device is further configured to receive the input data from the quantum computing system, via the non-unitary quantum communication channel, by processing one or more physical signals.

13. The system of claim 1, wherein:
the input data comprises a plurality of local density matrices, each local density matrix of the plurality of local density matrices corresponding to a respective qubit of an entangled quantum register and is obtained by performing a partial trace operation of a global density matrix;
the machine learning model is trained to reconstruct a global quantum state from the plurality of local density matrices by simulating the inverse of the non-unitary quantum communication channel; and
the output data is indicative of the global quantum state.

14. A system comprising:
a memory; and
at least one processing device, operatively coupled with the memory, to:
cause a sequence of measurements of a quantum state of a quantum system to be obtained, wherein the sequence of measurements comprises multiple measurements captured in a temporal order, wherein each measurement of the sequence of measurements corresponds to a respective segment of a communication line, and wherein each measurement of the sequence of measurements simulates a respective amount of noise added to an original quantum state by a non-unitary quantum communication channel at a respective time step;
generate a training dataset comprising the sequence of measurements of the quantum state; and
train, using the training dataset, a machine learning model to predict the original quantum state in order to perform at least one of error mitigation or quantum state preparation by simulating an inverse of the non-unitary quantum communication channel to reverse one or more errors caused by the non-unitary quantum communication channel.

15. The system of claim 14, wherein each measurement of the sequence of measurements of the quantum state is a weak measurement of the quantum state that does not fully collapse a wave function corresponding to the quantum state.

16. The system of claim 14, wherein the machine learning model comprises at least one of: a diffusion model, a recurrent neural network, an encoder-decoder network, or a vision transformer architecture.

17. The system of claim 14, wherein, to train the machine learning model to predict the original quantum state by simulating the inverse of the non-unitary quantum communication channel, the at least one processing device is to train the machine learning model to perform a reverse diffusion process to predict a backward evolution of noise added to the original quantum state in accordance with a forward diffusion process.

18. The system of claim 17, wherein:
the forward diffusion process comprises one or more iterations; and
to train the machine learning model to predict the original quantum state by simulating the inverse of the non-unitary quantum communication channel, the at least one processing device is further to perform each iteration of the one or more iterations of the forward diffusion process by:
initializing a first quantum state represented by a first density matrix associated with a Hilbert space;
determining, based on the density matrix, whether a purity of the first quantum state satisfies a threshold condition defined based on a maximally mixed quantum state for the Hilbert space; and
in response to determining that the purity of the first quantum state satisfies the threshold condition, modifying the first density matrix to obtain a second density matrix representing a second quantum state.

19. The system of claim 18, wherein:
determining whether the purity of the first quantum state satisfies the threshold condition comprises determining whether a trace determined from the first density matrix is greater than or equal to a threshold value defined based on a trace determined for the maximally mixed quantum state; and
modifying the first density matrix to obtain the second density matrix comprises applying a randomly selected basis measurement to the first density matrix.

20. A method comprising:
providing, to a machine learning model, input data indicative of an original quantum state of a quantum system that is modified by an amount of noise added by a non-unitary quantum communication channel, wherein the machine learning model is trained to predict the original quantum state in order to perform error mitigation by simulating an inverse of the non-unitary quantum communication channel to reverse one or more errors caused by the non-unitary quantum communication channel;
obtaining, from the machine learning model, output data indicative of the original quantum state; and
causing a quantum computing system to perform at least one quantum computing operation, involving at least one of error mitigation or quantum state preparation, based on the output data.
